(19) United States
(12) Patent Application Publication
(10) Pub. No.: US 2023/0234258 A1
(43) Pub. Date: Jul. 27, 2023

(54) MOLDABLE AND MOLDED CELLULOSE-BASED STRUCTURAL MATERIALS, AND SYSTEMS AND METHODS FOR FORMING AND USE THEREOF

(71) Applicant: UNIVERSITY OF MARYLAND, COLLEGE PARK, College Park, MD (US)

(72) Inventors: Liangbing HU, Rockville, MD (US); Shaoliang XIAO, Harbin (CN); Chaoji CHEN, Sykesville, MD (US); Yu LIU, Berwyn Heights, MD (US)

(21) Appl. No.: 17/919,411

(22) PCT Filed: Apr. 22, 2021
(86) PCT No.: PCT/US21/28541

§ 371 Date: Oct. 17, 2022

Related U.S. Application Data
(60) Provisional application No. 63/013,955, filed on Apr. 22, 2020.

(51) Int. Cl. B27K 3/02; C08H 8/00; B27K 3/16

(52) U.S. Cl. CPC B27K 3/0278; C08H 8/00; B27K 3/16; B27K 2240/10; B27K 2200/10

(57) ABSTRACT

Naturally-occurring cellulose-based material, such as wood, bamboo, grass, or reed, can be subjected to one or more chemical treatments to remove at least some lignin therefrom. The resulting partially-delignified material can be partially dried or fully dried and then rehydrated to yield a moldable cellulose-based material. The moldable material can be formed from a substantially flat planar configuration into a non-planar three-dimensional configuration. Once formed into a desired configuration, the moldable material can be fully dried to set its shape, thereby forming a rigid molded piece. In some embodiments, the molded piece can be used as a structural material, for example, to form a load-bearing structure or part of a composite load-bearing structure.

### CROSS-REFERENCE TO RELATED APPLICATION

The present application claims the benefit of U.S. Provisional Application No. 63/013,955, filed Apr. 22, 2020, entitled “Foldable, Structural Plant-Based Materials and Methods of Making, Folding, and Cutting the Same,” which is incorporated by reference herein in its entirety.

### FIELD

The present disclosure relates generally to processing of naturally-occurring cellulose-based materials, and more particularly, to forming and use of fibrous plant materials to make moldable pieces and molded structural materials.

### SUMMARY

Embodiments of the disclosed subject matter provide a “top-down” approach that can process wood or other fibrous plant materials (e.g., bamboo) into arbitrary three-dimensional (3-D) shapes while significantly increasing mechanical strength thereof. In some embodiments, natural plant material is subjected to one or more chemical treatments to remove at least some lignin therefrom (e.g., partial delignification), thereby softening the natural plant material. Subsequent drying of the partially-delignified plant material leads to shrinking of vessels and fibers of the plant microstructure. In some embodiments, the drying is followed by “shocking” the material in fluid (e.g., water) to selectively open the vessels. This rapid “fluid-shock” process forms a unique partially open, wrinkled cell wall structure that provides space for compression as well as the ability to support high strain, allowing the material to be easily folded and molded. Alternatively, in some embodiments, the material is only partially dried, such that vessels remain substantially open, thereby allowing folding and molding of the material. The different shapes and structures that can be achieved with these moldable plant materials can then be set into place by further drying to remove remaining fluid (e.g., to have a moisture content of 15 wt % or less), thereby forming a rigid 3-D molded plant-based structure.

In some embodiments, the cell wall engineering process described herein can maintain the intrinsic anisotropic microstructure of the plant material and can enhance interactions among the cellulose-based fibers within the cell walls. Such interactions can further enhance mechanical properties of the engineered plant-based material. Accordingly, in some embodiments, the partially-delignified plant-based material can be molded into a 3-D shape and set to form a structural material or a part of a composite structural material. For example, in some embodiments, a honeycomb core material can be formed from wood veneers (e.g., produced by roll-to-roll rotary cutting). When the honeycomb core material is combined with support plates (e.g., aluminum plates), the resulting structural material can demonstrate a tensile strength of ˜300 MPa, similar to Al alloys, but with a density of just ˜0.75 g/cm³ and at lower cost. Other 3-D structures and uses are also possible according to one or more embodiments of the disclosed subject matter.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIG. 1 is a simplified process flow diagram of a method for forming a moldable piece of naturally-occurring cellulose-based material and forming molded structural materials therefrom, according to one or more embodiments of the disclosed subject matter.

FIG. 2A illustrates radial, longitudinal, and rotary cut pieces of natural wood that may be used to form a moldable piece of naturally-occurring cellulose-based material, according to one or more embodiments of the disclosed subject matter.

FIG. 2B is a simplified cross-sectional view illustrating the microstructure of natural wood including cellulose-based longitudinal cells.

FIG. 2C is a scanning electron microscopy (SEM) image of a cross-section, in a direction perpendicular to the longitudinal wood growth direction, of the natural wood.

FIG. 2D is a simplified schematic diagram illustrating the hierarchical aligned structure of cellulose fibers in natural wood.

FIG. 3A is a simplified partial cut-away view of a natural bamboo segment that may be used to form a moldable piece of naturally-occurring cellulose-based material, according to one or more embodiments of the disclosed subject matter.

FIG. 3B is a top view image of a cross-section of a natural bamboo segment.

FIG. 3C is a magnified image of the culm of the natural bamboo segment of FIG. 2B.

FIG. 3D is a further magnified image showing the hierarchical microstructure of the culm wall of FIG. 3C.

FIG. 4A shows various stages in a first exemplary formation of a moldable piece of wood using a fluid shock treatment, according to one or more embodiments of the disclosed subject matter, including SEM images and diagrammatic illustrations of a cross-section of the wood at various stages and diagrammatic illustrations of cellulose nanofibers forming the walls of the longitudinal cells of the wood at various stages.

FIG. 4B shows various stages in a second exemplary formation of a moldable piece of wood without using a fluid shock treatment, according to one or more embodiments of the disclosed subject matter, including SEM images and diagrammatic illustrations of a cross-section of the wood at various stages and diagrammatic illustrations of cellulose nanofibers forming the walls of the longitudinal cells of the wood at various stages.

FIG. 5A is a perspective view of a moldable piece of naturally-occurring cellulose-based material with exemplary folding or bending axes, according to one or more embodiments of the disclosed subject matter.

FIG. 5B is a side view of the moldable piece of FIG. 5A with exemplary folding or bending positions.

FIG. 5C illustrate exemplary folding of the moldable piece of FIG. 5B.

FIGS. 6A-6L illustrate exemplary folding configurations for a moldable piece of naturally-occurring cellulose-based material, according to one or more embodiments of the disclosed subject matter.

FIGS. 7A-7B illustrate exemplary bent configurations for a moldable piece of naturally-occurring cellulose-based material, according to one or more embodiments of the disclosed subject matter.

FIG. 8 illustrates an exemplary repeating, undulating configuration for a moldable piece of naturally-occurring cellulose-based material, according to one or more embodiments of the disclosed subject matter.

FIG. 9 illustrates an exemplary fabrication setup for forming a moldable piece of naturally-occurring cellulose-based material to have the undulating configuration of FIG. 8 using a mold, according to one or more embodiments of the disclosed subject matter.

FIG. 10A is a simplified side view of an exemplary fabrication setup for continuously forming a moldable piece of natural wood to have the undulating configuration of FIG. 8 using a fluid shock treatment, according to one or more embodiments of the disclosed subject matter.

FIG. 10B is a simplified side view of another exemplary fabrication setup for continuously forming a moldable piece of natural wood to have the undulating configuration of FIG. 8 without a fluid shock treatment, according to one or more embodiments of the disclosed subject matter.

FIG. 11A is a side view of an exemplary multilayer structure formed by regularly arranged molded pieces having the undulating configuration of FIG. 8, according to one or more embodiments of the disclosed subject matter.

FIG. 11B is a side view of an exemplary multilayer structure formed by symmetrically arranged molded pieces having the undulating configuration of FIG. 8, according to one or more embodiments of the disclosed subject matter.

FIG. 12A is a top view of the undulating configuration of FIG. 8, showing exemplary cut planes for forming structural segments, according to one or more embodiments of the disclosed subject matter.

FIG. 12B is a side view illustrating an exemplary assembly of molded structural segments of the undulating configuration to form a structural material with a honeycomb configuration, according to one or more embodiments of the disclosed subject matter.

FIG. 12C is a perspective view illustrating an exemplary assembly of a honeycomb structural material with a pair of support plates to form a composite structure, according to one or more embodiments of the disclosed subject matter.

FIG. 12D is a simplified side view of the composite structure formed by the assembly of FIG. 12C, according to one or more embodiments of the disclosed subject matter.

FIG. 13A is a graph of stiffness versus density for a molded piece of wood (3-D molded wood) as compared to natural wood species and polymers.

FIG. 13B is a graph of specific compressive strengths of composite structures having the honeycomb configuration formed by a molded piece of wood (3-D molded wood) versus having the honeycomb configuration formed by aluminum (Al-5052).

FIG. 14A is a graph illustrating a time line of water content in the fabrication of non-moldable wood, moldable wood, and 3-D molded wood.

FIGS. 14B-14C are images of shrunken wood in a dry state and moldable wood in a wet state, respectively.

FIG. 15A illustrates a comparative process flow for forming a hole in compressed wood resulting in wood fiber breakage at the edge of the hole.

FIG. 15B illustrates an exemplary process flow for forming a hole in moldable wood to avoid wood fiber breakage at the edge of the hole.

### DETAILED DESCRIPTION

### General Considerations

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one of ordinary skill in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods, as known to those of ordinary skill in the art. When directly and explicitly distinguishing embodiments from discussed prior art, the embodiment numbers are not approximates unless the word “about” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein, but are not intended to be limiting. For example, certain terms may be used such as “inner,” “outer,”, “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part and the object remains the same.

As used herein, “comprising” means “including,” and the singular forms “a” or “an” or “the” include plural references unless the context clearly dictates otherwise. The term “or” refers to a single element of stated alternative elements or a combination of two or more elements, unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Overview of Terms

The following explanations of specific terms and abbreviations are provided to facilitate the description of various aspects of the disclosed subject matter and to guide those of ordinary skill in the art in the practice of the disclosed subject matter.

Naturally-occurring cellulose-based material: A portion (e.g., a cut portion, via mechanical means or otherwise) of any photosynthetic eukaryote of the kingdom Plantae in its native state as grown. In some embodiments, the naturally-occurring cellulose-based material comprises wood (e.g., hardwood or softwood), bamboo (e.g., any of Bambusoideae, such as but not limited to Moso, Phyllostachys vivax, Phyllostachys viridis, Phyllostachys bambusoides, and Phyllostachys nigra), reed (e.g., any of common reed (Phragmites australis), giant reed (Arundo donax), Burma reed (Neyraudia reynaudiana), reed canary-grass (Phalaris arundinacea), reed sweet-grass (Glyceria maxima), small-reed (Calamagrostis species), paper reed (Cyperus papyrus), bur-reed (Sparganium species), reed-mace (Typha species), cape thatching reed (Elegia tectorum), and thatching reed (Thamnochortus insignis)), or grass (e.g., a species selected from the Poales order or the Poaceae family). Alternatively or additionally, in some embodiments, the naturally-occurring cellulose-based material can be any type of fibrous plant composed of lignin, hemicellulose, and cellulose and having a microstructure with diameters of some lumina formed by cells being larger than that of others.

Longitudinal growth direction: A direction along which a plant grows from its roots or from a trunk thereof, with cellulose nanofibers form cell walls of the plant being generally aligned with the longitudinal growth direction. In some cases, the longitudinal growth direction may be generally vertical or correspond to a direction of its water transpiration stream. This is in contrast to the radial growth direction, which extends from a center portion of the plant outward and may be generally horizontal.

Delignification: The removal of some (e.g., at least 0.1%) or but not all (e.g., less than 99%) of naturally-occurring lignin from the naturally-occurring cellulose-based material. Lignin content within the cellulose-based material before and after delignification can be assessed using known techniques in the art, for example, Laboratory Analytical Procedure (LAP) TP-510-42618 for “Determination of Structural Carbohydrates and Lignin in Biomass,” Version Aug. 3, 2012, published by National Renewable Energy Laboratory (NREL), and ASTM E1758-01(2020) for “Standard Test Method for Determination of Carbohydrates in Biomass by High Performance Liquid Chromatography,” published by ASTM International, both of which are incorporated herein by reference.

Moisture content: The amount of fluid, typically water, retained within the microstructure of the plant material. In some embodiments, the moisture content (MC) can be determined by oven-dry testing, for example by calculating the change in weight achieved by oven drying (e.g., at 103° C. for 6 hours) the plant material, using the equation: MC (%)=weight before dry−weight after dry/weight after dry×100. Alternatively or additionally, moisture content can be assessed using known techniques in the art, for example, an electrical moisture meter or other techniques disclosed in ASTM D4442-20 (2020) for “Standard Test Methods for Direct Moisture Content Measurement of Wood and Wood-based Materials,” published by ASTM International, which standard is incorporated herein by reference.

Monolithic: A single continuous piece, as contrasted with a single piece formed by joining or combining multiple subpieces (e.g., laminate).

Fatigue free: Capable of repeated folding or bending actuation without evidence of material failure, such as plastic deformation, notch or crease formation, breaking, fraying, etc.

Shaping: Bending, folding, pushing, pressing, or otherwise non-destructively forming (e.g., without removal of the cellulose-based material) a piece of material into a desired configuration.

Three-dimensional (3-D) configuration: As contrasted with a substantially-flat planar configuration (where cellulose nanofibers are substantially aligned along a common direction), a 3-D configuration is one where a single monolithic piece has been shaped such that a least one exterior surface thereof has portions that are not coplanar, such that cellulose nanofibers in one portion are no longer aligned with cellulose nanofibers in another portion, such that the piece does not have an overall parallelepiped shape, or any combination thereof.

### Introduction

In embodiments, the microstructure of naturally-occurring cellulose-based materials can be modified to provide the materials with a more flexible nature. The modification can include the removal of some of, but not all lignin, from the natural material by one or more chemical treatments (e.g., partial delignification). In some embodiments, the modification substantially retains the cellulose-based longitudinal cells in the microstructure of the natural material; however, sufficient lignin can be removed to cause gaps to form between some adjacent cells. When the partially-delignified material is subsequently dried after the chemical treatments, the lumina of the cells in the microstructure can shrink or crumple. In some embodiments, the partially-delignified material can be fully dried (e.g., to have a moisture content ≤15 wt %), which causes the lumina to substantially collapse. After drying, the partially-delignified material can be rehydrated by partial or full immersion in a fluid for a short duration (e.g., less than 5 minutes). This “fluid shock” can cause some of the lumina to reopen while others may remain substantially collapsed. The rehydrated material can be more flexible as compared to the natural material. Alternatively, in some embodiments, the partially-delignified material can be partially dried (e.g., to have a moisture content ≥35 wt %), such that at least some lumina are collapsed or shrunken. The partially dried material may also be more flexible as compared to the natural material.

In some embodiments, the more-flexible, or moldable, cellulose-based materials can be arbitrarily shaped, for example, by folding, bending, using a compression mold, or any other technique. In some embodiments, the moldable cellulose-based material may initially be provided as a thin, flat piece, for example, having a thickness less than or equal to 10 mm. The moldable material can then be folded, bent, or otherwise shaped about any direction, at any position, and at any angular orientation (e.g., 0 to 180° inclusive) to form arbitrary, complex 3-D structures. For example, in some embodiments, the moldable cellulose-based materials can be cut and/or folded to produce complex 3-D structures, similar to the traditions of origami and/or kirigami.

As long as the cellulose-based material retains sufficient fluid content (e.g., moisture content ≥35 wt %), the material may remain moldable/flexible. By fully drying the material when configured in a particular shape (e.g., to have a moisture content ≤15 wt %), the material can be “set” to retain the shape, thereby forming a rigid molded structure that would be plastically deformed by any further shaping. The resulting molded material can exhibit enhanced mechanical properties as compared to the original natural material. For example, in some embodiments, the molded material is a rigid, monolithic piece that can be used as a structural material or integrated with other materials to form a composite structural material. Alternatively, in some embodiments, the moldable material may be kept in a hydrated state to maintain flexibility thereof, for example, for use as flexible substrate or other support structure.

The cell wall engineering approach disclosed herein can radically expand the capabilities of natural plant materials (e.g., wood, bamboo, grass, etc.) as lightweight structural materials beyond conventional planar structures to complex 3D designs and components with greater versatility.

### Method Examples

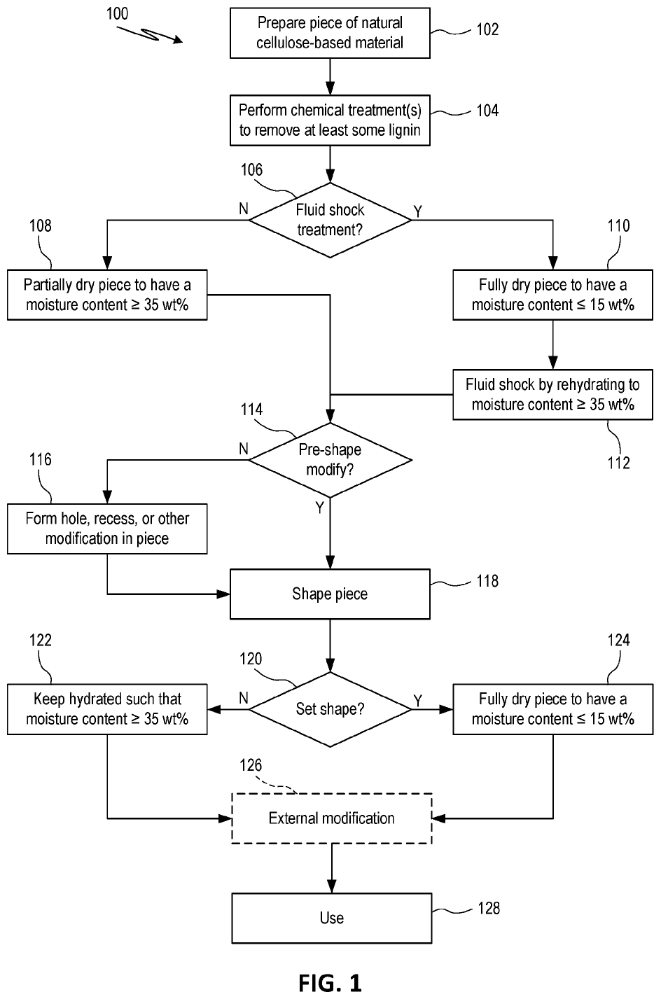

FIG. 1 illustrates an exemplary method 100 for forming moldable structures from naturally-occurring cellulose-based materials and subsequent use thereof. In some embodiments, the plant material is wood, bamboo, grass, or reed. However, in other embodiments, the plant material can be any type of fibrous plant composed of lignin, hemicellulose, and cellulose and having a microstructure with diameters of some lumina formed by cells being larger than that of others. For example, the microstructure of the naturally-occurring cellulose-based material can have first lumina, which are formed by walls of first longitudinal cells (e.g., fibers, microfibrils, or tracheids) and have a first cross-sectional size, and second lumina, which are formed by walls of second longitudinal cells (e.g., vessels) and have a second cross-sectional size larger than the first cross-sectional size.

The method 100 can begin at process block 102, where a piece of natural cellulose-based material is prepared. For example, the preparing of process block 102 can include cutting, removing, or otherwise separating the piece of natural cellulose-based material from a parent plant. In some embodiments, the cutting can form the cellulose-based material into a substantially flat planar structure, with a direction of cellulose fibers extending parallel to a plane of the structure. Optionally, in some embodiments, the preparing can include pre-processing of the piece of natural cellulose-based material, for example, cleaning to remove any undesirable material or contamination in preparation for subsequent processing, forming the natural cellulose-based material into a particular shape in preparation for subsequent processing (e.g., slicing into strips), softening or flattening of the cellulose-based material (e.g., using a steam treatment), or any combination of the foregoing.

At process block 104, the cellulose-based material is subjected to one or more chemical treatments to remove at least some lignin therefrom, for example, by immersion of the natural cellulose-based material (or a portion thereof) in a chemical solution associated with the treatment. In some embodiments, each chemical treatment or only some chemical treatments can be performed under vacuum, such that the solution associated with the treatment is encouraged to fully penetrate the cell walls and lumina of the natural cellulose-based material. Alternatively, in some embodiments, the chemical treatment(s) can be performed under ambient pressure conditions or elevated pressure conditions (e.g., ˜6-8 bar). In some embodiments, each chemical treatment or some chemical treatments can be performed at any temperature between ambient (e.g., ˜23° C.) and an elevated temperature where the solution associated with the chemical treatment is boiling (e.g., ˜70-160° C.). In some embodiments, the solution is not agitated in order to minimize the amount of disruption to the microstructure of the natural cellulose-based material.

In some embodiments, the immersion time can range anywhere from 0.1 hours to 96 hours, for example, between 4 hours and 12 hours, inclusive. The amount of time of immersion within the solution may be a function of amount of lignin to be removed, size of the piece, temperature of the solution, pressure of the treatment, and/or agitation. For example, smaller amounts of lignin removal, smaller piece size, higher solution temperature, higher treatment pressure, and agitation may be associated with shorter immersion times, while larger amounts of lignin removal, larger piece size, lower solution temperature, lower treatment pressure, and no agitation may be associated with longer immersion times.

In some embodiments, the solution of the chemical treatment comprises an alkaline solution. In some embodiments, the solution of the chemical treatment can include sodium hydroxide (NaOH), lithium hydroxide (LiOH), potassium hydroxide (KOH), sodium sulfite (Na₂SO₃), sodium sulfide (Na₂S), NaₙS (where n is an integer), urea (CH₄N₂O), sodium bisulfite (NaHSO₃), sulfur dioxide (SO₂), anthraquinone (AQ) (C₁₄H₈O₂), methanol (CH₃OH), ethanol (C₂H₅OH), butanol (C₄H₉OH), formic acid (CH₂O₂), hydrogen peroxide (H₂O₂), acetic acid (CH₃COOH), butyric acid (C₄H₈O₂), peroxyformic acid (CH₂O₃), peroxyacetic acid (C₂H₄O₃), ammonia (NH₃), tosylic acid (p-TsOH), sodium hypochlorite (NaClO), sodium chlorite (NaClO₂), chlorine dioxide (ClO₂), chorine (Cl₂), or any combination of the above. Exemplary combinations of chemicals for the chemical treatment can include, but are not limited to, NaOH +Na₂SO₃, NaOH+Na₂S, NaOH+urea, NaHSO₃+SO₂+H₂O, NaHSO₃+Na₂SO₃, NaOH+Na₂SO₃, NaOH+AQ, NaOH+Na₂S+AQ, NaHSO₃+S₀₂+H₂O+AQ, NaOH+Na₂SO₃+AQ, NaHSO₃+AQ, NaHSO₃+Na₂SO₃+AQ, Na₂SO₃+AQ, NaOH+Na₂S+NaₙS (where n is an integer), Na₂SO₃+NaOH+CH₃OH+AQ, C₂H₅OH+NaOH, CH₃OH+HCOOH, NH₃+H₂O, and NaClO₂+acetic acid.

The chemical treatment can continue (or can be repeated with subsequent solutions) until a desired reduction in lignin content in the natural cellulose-based material is achieved. The lignin content can be reduced to between 0.1% (lignin content is 0.1% of original lignin content in the natural cellulose-based material) and 99% (lignin content is 99% of original lignin content in the natural cellulose-based material), depending upon the desired application. For example, in some embodiments where it may be desirable to retain as much of the natural cellulose-based material as possible, the reduction in lignin content can be relatively small, for example, such that the lignin content is reduced by no more than 10% as compared to the original lignin content of the natural cellulose-based material. In some embodiments, greater amounts of lignin can be removed, such as at least 90% of the original lignin content is removed (e.g., 90-100% lignin removed). In some embodiments, the lignin content is reduced by 50% or less as compared to the original lignin content in the natural cellulose-based material. In some embodiments, the chemical treatment reduces the hemicellulose content at the same time as the lignin content, for example, to the same or lesser extent as the lignin content reduction.

In some embodiments, when the natural cellulose-based material is hardwood, the lignin content after the delignification of process block 104 can be at least 10 wt % (e.g., in a range of 10-15 wt %, inclusive). In some embodiments, when the natural cellulose-based material is softwood, the lignin content after the delignification of process block 104 can be at least 12.5 wt % (e.g., 12.5-17.5 wt %, inclusive). In some embodiments, when the natural cellulose-based material is bamboo, the lignin content after the delignification of process block 104 can be at least 13 wt % (e.g., 13-18 wt %, inclusive). The removal of lignin from the natural plant material can result in enlargement of the cellular lumina and enhanced hydrophilicity.

In some embodiments, process block 104 can further include an optional rinsing step after the chemical treatment(s), for example, to remove residual chemicals or particulate resulting from the delignification process. For example, the delignified cellulose-based material can be partially or fully immersed in one or more rinsing solutions. The rinsing solution can be a solvent, such as but not limited to, de-ionized (DI) water, alcohol (e.g., ethanol, methanol, isopropanol, etc.), or any combination thereof. For example, the rinsing solution can be formed of equal volumes of water and ethanol. In some embodiments, the rinsing can be performed without agitation, for example, to avoid disruption of the microstructure. In some embodiments, the rinsing may be repeated multiple times (e.g., at least 3 times) using a fresh mixture rinsing solution for each iteration.

The method 100 can proceed to decision block 106, where it is determining if a fluid shock technique will be performed. If it is determined that a fluid shock will not be performed, the method 100 can proceed from decision block 106 to process block 108, where the partially-delignified cellulose-based material is partially dried. For example, the partial drying of process block 108 can be such that the cellulose-based material has a moisture content of at least 35 wt % (e.g., ≥50 wt %). Otherwise, if it is determined that a fluid shock will be performed, the method 100 can proceed from decision block 106 to process block 110, where the partially-delignified cellulose-based material is fully dried. For example, the full drying of process block 110 can be such that the cellulose-based material has a moisture content 15 wt % or less (e.g., around 8-12 wt %, inclusive).

The drying of either process block 108 or process block 110 can include any of conductive, convective, and/or radiative heating processes, including but not limited to an air-drying process, a vacuum-assisted drying process, an oven drying process, a freeze-drying process, a critical point drying process, a microwave drying process, or any combination of the above. For example, an air-drying process can include allowing the partially-delignified cellulose-based material to naturally dry in static or moving air, which air may be at any temperature, such as room temperature (e.g., 23° C.) or at an elevated temperature (e.g., greater than 23° C.). For example, a vacuum-assisted drying process can include subjecting the partially delignified cellulose-based material to reduced pressure, e.g., less than 1 bar, for example, in a vacuum chamber or vacuum oven. For example, an oven drying process can include using an oven, hot plate, or other conductive, convective, or radiative heating apparatus to heat the partially delignified cellulose-based material at an elevated temperature (e.g., greater than 23° C.), for example, 70° C. or greater. For example, a freeze-drying process can include reducing a temperature of the partially delignified cellulose-based material to below a freezing point of the fluid therein (e.g., less than 0° C.), then reducing a pressure to allow the frozen fluid therein to sublime (e.g., less than a few millibars). For example, a critical point drying process can include immersing the partially delignified cellulose-based material in a fluid (e.g., liquid carbon dioxide), increasing a temperature and pressure of the bamboo segment past a critical point of the fluid (e.g., 7.39 MPa, 31.1° C. for carbon dioxide), and then gradually releasing the pressure to remove the now gaseous fluid. For example, a microwave drying process can include using a microwave oven or other microwave generating apparatus to induce dielectric heating within the partially delignified cellulose-based material by exposing it to electromagnetic radiation having a frequency in the microwave regime (e.g., 300 MHz to 300 GHz), for example, a frequency of ˜915 MHz or ˜2.45 GHz.

In some embodiments, the full drying of process block 110 causes shrinkage of the delignified cellulose-based material, which in turn causes significant buckling of the cell walls. In some embodiments, the lumina formed by the longitudinal cells may collapse (e.g., fully collapse such that facing surface of the channel wall are in contact, or at least significantly narrow). After the drying of process block 110, the method 100 can proceed to process block 112, where the dried cellulose-based material is rehydrated using the fluid shock technique. For example, the dried cellulose-based material can be partially or fully immersed in a fluid (e.g., water, alcohol, or any combination thereof) for a short period of time (e.g., several minutes, such as 3 minutes or less, for example, on the order of seconds) such that the rehydrated material has a moisture content of at least 35 wt % (e.g., around 50 wt %). Methods for rehydration other than immersion in fluid are also possible according to one or more embodiments. For example, rehydration can be achieved by exposure to a humidified environment.

In some embodiments, the rehydration is effective to re-swell the cells wall and allow larger lumina (e.g., second lumina formed by the second longitudinal cells) to re-open while smaller lumina (e.g., first lumina formed by the first longitudinal cells) to remain substantially collapsed. The swelling introduced by the fluid shock can create wrinkles in the cell wall structure, which can allow the cellulose-based material to accommodate severe tension and compression without damage.

With the cellulose-based material having a moisture content of at least 35 wt % after either process block 108 or process block 112, the method 100 can proceed to decision block 114, where it is determined if a pre-shaping modification is desired. If such a modification is desired, the method 100 can proceed to process block 116, where a non-machining technique (e.g., without removing substantive amounts of material to form the modification) is used to form a hole, opening, recess, or other surface modification. The modification can be made while the moisture content of the partially-delignified cellulose-based material is at least 35 wt % and therefore in a substantially flexible/moldable state. As a result, the cellulose fibers may retain sufficient motility so as to bend around the formation of the hole, opening, or recess without breaking.

After the modification of process block 116, or if no modification was desired at decision block 114, the method 100 can proceed to process block 118, where the cellulose-based material is shaped to have a desired configuration, such as a 3-D configuration. The shaping of process block 118 can include bending, folding, pushing, pressing, molding (e.g., using a mold) or otherwise non-destructively forming (e.g., no removal of material) the partially-delignified cellulose-based material to have the desired configuration. During the shaping, the moisture content of the partially-delignified cellulose-based material is at least 35 wt % and therefore in a substantially flexible/moldable state. As a result, the partially-delignified cellulose-based material readily adopts the shaped configuration and can return its original unshaped configuration without damage.

The method 100 can proceed to decision block 120, where it is determined if the partially-delignified cellulose-based material should be set in the shaped configuration or if the partially-delignified cellulose-based material should instead be maintained in a flexible/moldable state. If it is desired to maintain the cellulose-based material as moldable material, the method 100 can proceed to process block 122, where the moisture content thereof is maintained at or above 35 wt %. Otherwise, if it is desired to set the cellulose-based material in the shaped configuration, the method 100 can proceed to process block 124, where cellulose-based material is fully dried while maintaining the shaped configuration, such that the moisture content thereof is reduced to at or below 15 wt %. The drying of process block 124 may be performed in a manner similar to that described above with respect to process block 110. Alternatively or additionally, in some embodiments, the drying can be a by-product of the shaping, for example, by using a hot press to simultaneously mold and dry the moldable cellulose-based material. In such embodiments, the shaping can be effective to further densify the cellulose-based material prior to fully drying, which densification may further improve the mechanical properties of the molded material. Once fully dried, the partially-delignified cellulose-based material is rigid and incapable of further shape manipulation without plastic deformation, thereby forming a molded structure.

In some embodiments, the method 100 can proceed from process block 122 or process block 124 to process block 126, where an optional external modification is applied. For example, the cellulose-based material can be sealed to prevent ingress of moisture or egress of moisture and thereby maintaining a desired moldable (e.g., flexible) or molded (e.g., rigid) state of the material. In some embodiments, the sealing is by placing the cellulose-based material in a sealed or controlled environment. Alternatively or additionally, the sealing can be achieved by a protective layer or coating provided over exposed surfaces of the cellulose-based material. For example, the protecting layer or coating can be a polyurethane coating, paint, silane hydrophobic coating, or any other coating effective to prevent, or at least restrict, movement of moisture into or out of the cellulose-based material. Alternatively or additionally, the external modification can include a destructive modification, for example, machining or cutting to prepare the cellulose-based material for subsequent use.

The method 100 can proceed to process block 128, where the partially-delignified cellulose-based material, in either the moldable state or molded state, can be used in a particular application or adapted for use in a particular application. In some embodiments, the molded partially-delignified cellulose-based materials can be used as a structural material, for example, assembled together with non-plant materials (e.g., metal, metal alloy, plastic, ceramic, composite, etc.) to form a heterogenous composite structure. Alternatively, in some embodiments, the moldable partially-delignified cellulose-based materials can be used as a flexible substrate or structure, for example, as a scaffold for robotic actuation or a substrate for electronics.

Although some of blocks 102-128 of method 100 have been described as being performed once, in some embodiments, multiple repetitions of a particular process block may be employed before proceeding to the next decision block or process block. In addition, although blocks 100-128 of method 100 have been separately illustrated and described, in some embodiments, process blocks may be combined and performed together (simultaneously or sequentially). For example, as noted above, the drying of process block 124 and the shaping of process block 118 may occur simultaneously. Moreover, although FIG. 1 illustrates a particular order for blocks 102-128, embodiments of the disclosed subject matter are not limited thereto. Indeed, in certain embodiments, the blocks may occur in a different order than illustrated or simultaneously with other blocks. For example, the modification of process block 116 can occur after the shaping of process block 118, while the partially-delignified cellulose-based material remains moldable.

### Wood Implementations

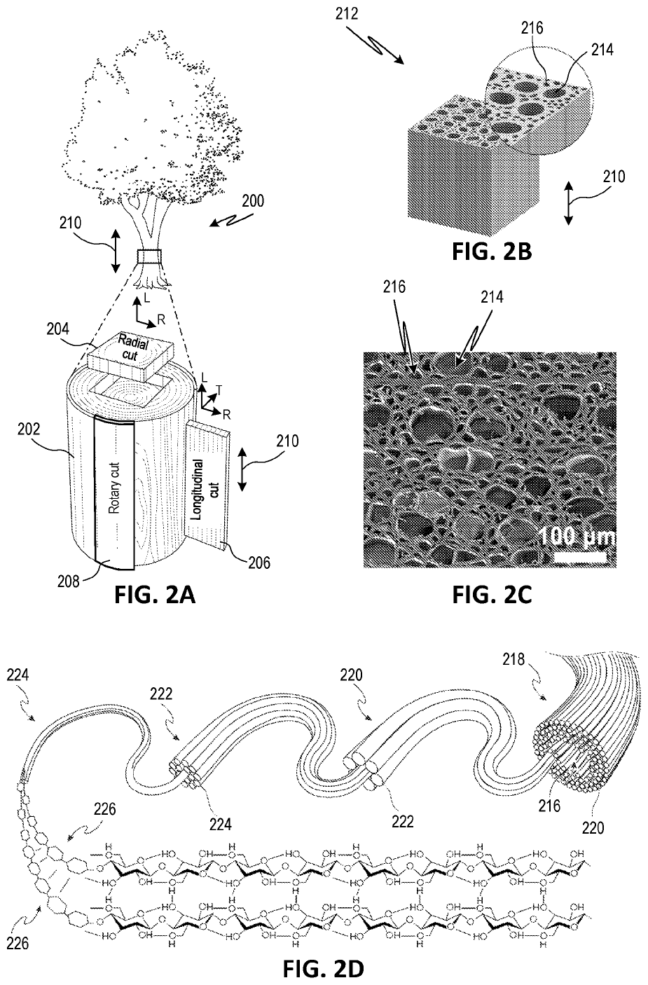

Natural wood has a unique three-dimensional porous structure with multiple channels or lumina formed by longitudinal cells, including vessels 214 (e.g., having a maximum cross-sectional dimension, or diameter, in a plane perpendicular to a length thereof of 40-80 μm, inclusive) and fibers 216 (e.g., having a maximum cross-sectional dimension, or diameter, in a plane perpendicular to a length thereof of 10-30 μm, inclusive) extending in a direction of wood growth 210, as illustrated by the exemplary section 212 of hardwood in FIGS. 2B-2C. Walls of cells in the natural wood are primarily composed of cellulose (40 wt % 50 wt %), hemicellulose (20 wt %˜30 wt %), and lignin (20 wt % 35 wt %), with the three components intertwining with each other to form a strong and rigid wall structure. The naturally-occurring cellulose exhibits a hierarchical structure. For example, as shown in FIG. 2D, the natural wood cell 218 has a plurality of cellulose fibers 220 surrounding and extending substantially parallel to lumen 216. The cellulose fibers 220 can be separated into constituent high-aspect-ratio microfibrils 222 in the form of aggregated three-dimensional networks (e.g., as bundles) that provide relatively high surface area. The cellulose microfibrils 222 can be further subdivided into elementary nanofibrils 224, which are composed of 12-36 linear polymer molecular chains 226. Each polymer molecular chain 226 is formed of thousands of repeating glucose units connected by strong covalent bonds that are arranged in a highly-ordered crystalline structure. The polymer molecular chains 226 are held together in a densely-packed arrangement forming the elementary nanofibril 224 by intramolecular hydrogen bonding between functional groups of adjacent molecular chains.

The piece of natural wood can be cut in any direction with respect to its longitudinal growth direction 210. Since the cellulose fibers 218 are naturally aligned with the growth direction, the cut direction will dictate the orientation of the cell lumina in the final structure, which orientation can affect the mechanical properties of the final moldable or molded wood structure. For example, in some embodiments, a piece of natural wood can be cut from a trunk 202 of tree 200 in a vertical or longitudinal direction (e.g., parallel to longitudinal wood growth direction 210) such that lumina of longitudinal cells are oriented substantially parallel to a major face (e.g., largest surface area) of the longitudinal-cut wood piece 206. Alternatively, in some embodiments, the piece of natural wood can be cut in a horizontal or radial direction (e.g., perpendicular to longitudinal wood growth direction 210) such that lumina of longitudinal cells are oriented substantially perpendicular to the major face of the horizontal-cut wood piece 204. Alternatively, in some embodiments, the piece of natural wood can be cut in a rotation direction (e.g., perpendicular to the longitudinal wood growth direction 210 and along a circumferential direction of the trunk 202) such that lumina of longitudinal cells are oriented substantially parallel to the major face of the rotary-cut wood piece 208. In some embodiments, the piece of natural wood can be cut at any other orientation between longitudinal, radial, and rotary cuts. For any of the cut directions, a thickness of the piece of natural wood can be measured in a direction perpendicular to the major face and may be 10 mm or less.

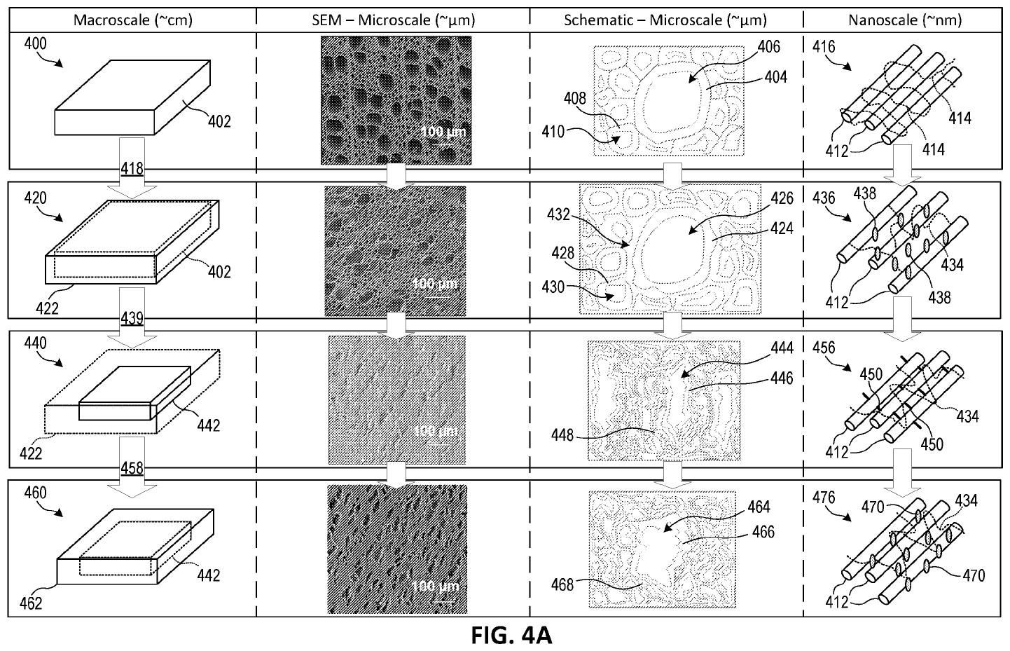

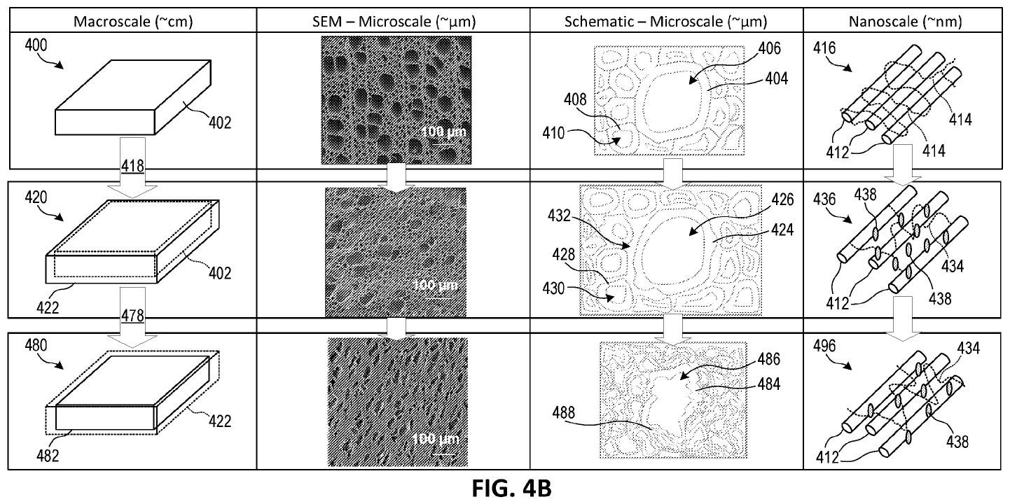

Referring to FIG. 4A, various stages in forming a moldable piece of wood using a fluid shock treatment are shown. As noted above, the natural wood 402 has vessels 404 and fiber cells 408 composed of cellulose, hemicellulose, and lignin. In particular, the walls of these cells, which form respective lumen 406 and lumen 410 extending in a longitudinal growth direction of the wood 402, exhibit a composite structure 416 with cellulose fibrils 412 bonded together by hemicellulose and lignin adhesive matrix 414, which is strong and rigid. In order to obtain a foldable structure, the natural wood 402 from initial stage 400 is subjected to a delignification process 418 via one or more chemical treatments. The lignin removal efficiency by the chemical treatment(s) can be a product of wood size, chemical treatment time, temperature, and chemical treatment condition (e.g., under vacuum or pressure), and/or selection of chemical reagents, among other factors. For example, the natural wood 402 can be partially or fully immersed in a boiling solution of NaOH and Na₂SO₃ for 6 hours, followed by one or more rinsing or washing solutions, in order to reduce lignin content in the wood by ˜55% and hemicellulose content by ˜67%. For example, when the natural wood is a hardwood, the wood piece 402 of stage 400 can have a composition of 45.1 wt % cellulose, 18.7 wt % hemicellulose, and 21.3 wt % lignin. After delignification 418, the delignified wood piece 422 of stage 420 can have a composition of 40.1 wt % cellulose, 6.1 wt % hemicellulose, and 9.5 wt % lignin.

The partial removal of hydrophobic lignin components (with remaining lignin 434 intertwining between microfibrils 412) results in softening and mild expansion in the wood size due to the absorption of water 438 by the cell walls 436, which features a higher fraction of hydrophilic cellulose. The delignified wood 422 thus exhibits enlarged cross-sectional sizes for lumen 426 and lumen 430, while the walls of vessels 424 and fibers 428 are thinned due to the partial removal of lignin and hemicellulose. Moreover, the partial delignification results in separation 432 between cell walls, which also contributes to volume swelling of the wood. For example, the moisture content of the partially-delignified wood 422 can be ˜75 wt %, and the volume of the delignified wood 422 can be 14-20% greater than the volume of the original natural wood 402.

After delignification 418, the partially-delignified wood 422 can be subjected to drying 439 until the moisture content therein is less than 15 wt % (e.g., 8-12 wt %). The resulting dried wood 442 at stage 440 can have a shrunken shape, for example, due to water evaporation from the cell walls. In terms of the microstructure, the vessels 446 after drying can shrink such that lumina 444 is about 1.5 μm along the transverse (T) direction of the wood and about 13.6 μm along the radial (R) direction of the wood. Meanwhile, the smaller sized fibers 448 in the dried wood 442 can be substantially collapsed, with a dimension along the T direction of nearly 0 μm and a dimension along the R direction of 9.6 μm. As a result, the microstructure of the dried wood exhibits a large deformation space in the T and R directions, for example, such that a volume of the dried wood 442 is 59-63% less than a volume of the wet partially-delignified wood 422 of stage 420. Meanwhile, within the cell walls 456, adjacent microfibrils 412 are pulled together by the capillary effects of water evaporation, and hydrogen bonds 450 can be formed between the cellulose of the microfibrils 412.

After the drying 439, the dried wood 442 can be rehydrated using the fluid shock treatment 458 until the moisture content therein is greater than 35 wt % (e.g., ≥50 wt %). The resulting moldable wood 462 at stage 460 can swell due to reabsorption of water. For example, the volume of the moldable wood 462 can increase 67.6% as compared to the dried wood 442. While volume of the moldable wood 462 may still be less than the original natural wood 402. In terms of its microstructure, the fluid shock treatment causes the lumina 464 of the larger sized vessels 466 to expand and at least partially open, albeit with a wrinkled and more flexible configuration as compared to the original vessels 404. During the fluid shock treatment 458, the re-opening of the vessels 466 may occur rapidly (e.g., on the order of seconds, such as 3 seconds), while the morphology of the smaller fibers 468 remains relatively unchanged during the treatment time (e.g., on the order of minutes, such as 3 minute). Meanwhile, the smaller fibers 468 remain substantially closed despite the rehydration. Such selective opening of the cell wall microstructure can may provide two simultaneous effects: (1) the partially open vessels create space within the moldable wood 462 that can accommodate both compressive and tensile deformation in an “accordion-like” manner while allowing the material to undergo severe compression and tension while being folded (e.g., even up to 180° without fracture); and (2) the densely-packed substantially-closed fibers 468 can provide mechanical support for enhanced strength. Within the cell walls 476, the reintroduction of water 470 can break the hydrogen bonds 450 that interconnected the cellulose microfibrils 412 in the dry state, thereby allowing the microfibrils to move more easily with respect to each other.

The moisture content can greatly influence the modulus and strain of the moldable wood 462. For example, for a moisture content of 100%, the moldable wood 462 can exhibit a 92-times reduction in modulus and 8.8-times increase in strain along T direction compared with that of dried wood 442 having a moisture content of only 10 wt %. The delignified wood can thus change between a substantially rigid state and a flexible/moldable state merely by changing the moisture content. At higher moisture contents (e.g., greater than 25-35 wt %), the transformation in modulus leads to excellent foldability.

Foldability does not rely on moisture content alone. Rather, the foldability of moldable wood 462 is a cooperative effect resulting from the space shrinkage introduced by drying and the fluid lubrication introduced by rehydration. Thus, for wet natural wood 402, which has sufficient moisture content but no shrinkage/crumpling of the microstructure, the wood 402 cannot be bent without breaking. Similarly, for dried wood 442, which has shrinkage/crumpling of the microstructure but insufficient moisture content, the wood 442 cannot be bent without breaking. The moldable wood 462, however, combines both shrinkage/crumpling of the microstructure and sufficient moisture content, thereby allowing the wood 462 to be readily folded without breakage.

In some embodiments, a similar effect can be achieved by replacing the drying and fluid shock treatments of FIG. 4A with partial drying. For example, FIG. 4B illustrates various stages in forming a moldable piece of wood using partial drying instead of a fluid shock treatment. The delignification 418 of the natural wood 402 may occur in a similar manner to that described above with respect to FIG. 4A. However, instead of fully drying the partially-delignified wood 422 after stage 420, the wood 422 is instead subjected to partial drying 478 until the moisture content therein is reduced but still greater than or equal to 35 wt % (e.g., ˜50 wt %). The resulting partially-dried wood 482 at stage 480 thus attains a similar microstructure, where lumina 486 of vessels 484 remain at least partially open with a wrinkled cell wall and smaller fibers 488 are substantially collapsed or at least narrowed. Moreover, water 438 retained within cell walls 496 can act to provide the lubrication necessary for flexibility. Thus, the partially-dried wood 482 may also exhibit excellent foldability and be considered a moldable wood.

The moldable wood 462 or 482 that results from these cell wall engineering techniques can be processed into various shapes by mechanical bending, folding, and twisting. Once a desired configuration is achieved, the moldable wood 462 or 482 can then be dried to set or fix its shape, thereby forming a final, molded wood structure that is substantially rigid (e.g., cannot be further manipulated without plastic deformation or breakage). The outstanding foldability of the moldable wood 462, 482 and the excellent stability of molded wood after drying offers the potential for designing and fabricating complex 3-D shapes, for example, as independent structural materials or as part of a composite structural materials.

### Bamboo Implementations

Although the discussion above has focused on wood, other fibrous plant materials which have longitudinal cells that form lumina of different sizes, can also be processed to achieve the same effect. For example, bamboo can be processed in a manner similar to that described above for wood to yield a partially-delignified bamboo that can be molded.

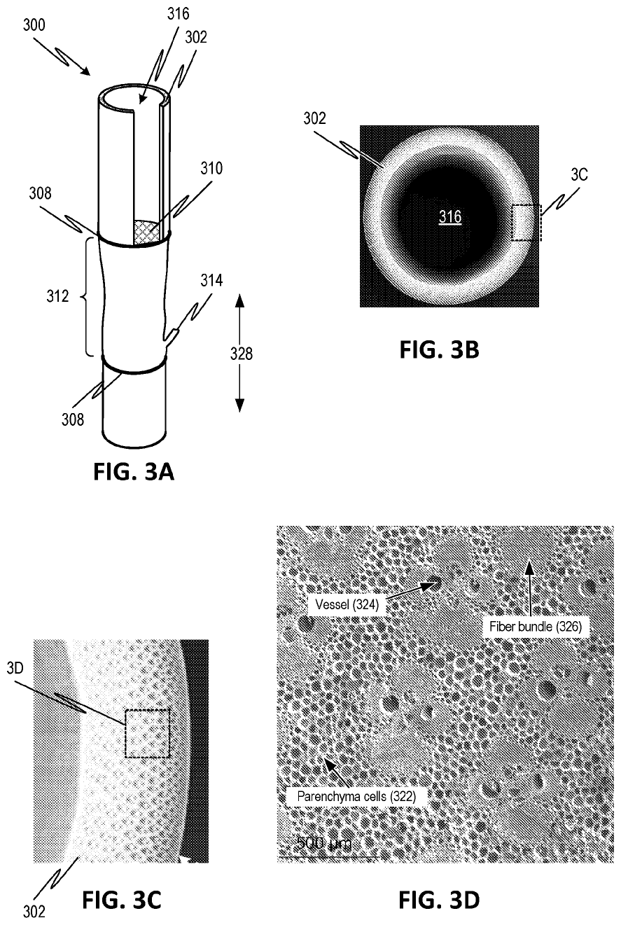

FIG. 3A shows a partial cutaway view of a bamboo segment 300 in its naturally-occurring state. The segment 300 has a culm wall 302 surrounding a hollow interior region 316, which is divided along a length of the culm wall 302 into internal nodal regions 312 by nodes 308 formed by an internal nodal diaphragm 310. The culm wall 302 has fibers extending along a longitudinal direction 328 (e.g., bamboo growth direction or a direction substantially parallel to an axis defined by the hollow interior region 316 of the bamboo segment 300) that are embedded in a lignin matrix. One or more branch stubs 314 can extend from a particular internal nodal region 312 and can serve as the root from which a culm wall for a new bamboo segment may grow (e.g., thus defining a different longitudinal direction for the new segment).

Within the culm wall 302, the bamboo exhibits a hierarchical cellular structure with porous cells that provide nutrient transport and dense cells that provide mechanical support. For example, FIGS. 3B-3D show images of a cross-section of a bamboo segment 300, in particular, illustrating the microstructure of parenchyma cells 322, vessels 324, and fiber bundles 326 that constitute the culm wall 302. The fiber bundles 326 are highly aligned and extend substantially parallel to the longitudinal direction 328 whereas parenchyma cells 322 can be parallel or perpendicular to the longitudinal direction 328. Each vessel 324 defines an open lumen that extends along the longitudinal direction 328. Moreover, the elementary fibers that form the fiber bundles 326 may also have irregular small lumina in a center thereof. The fiber bundles 326, parenchyma cells 322, and vessels 324 adhere to each other via a low strength polymer matrix composed of lignin and hemicellulose.

Similar to the wood examples, partial delignification of the bamboo 300 can lead to softening and mild expansion in the bamboo size due to absorption of water by the respective cell walls. The corresponding lumina of the cells can thus be enlarged. In some embodiments, the partially-delignified bamboo can be fully dried (e.g., moisture content ≤15 wt %) such that the lumina of the vessels and the elementary fibers shrink, after which the bamboo can be rehydrated (e.g., moisture content ≥35 wt %) via the fluid shock technique to selectively open the vessel lumina while the fiber lumina remain substantially closed or at least narrowed, thereby yielding a moldable bamboo. Alternatively, in some embodiments the partially-delignified bamboo can be partially dried (e.g., moisture content ≥35 wt %) to yield a moldable bamboo.

### Shaping Examples

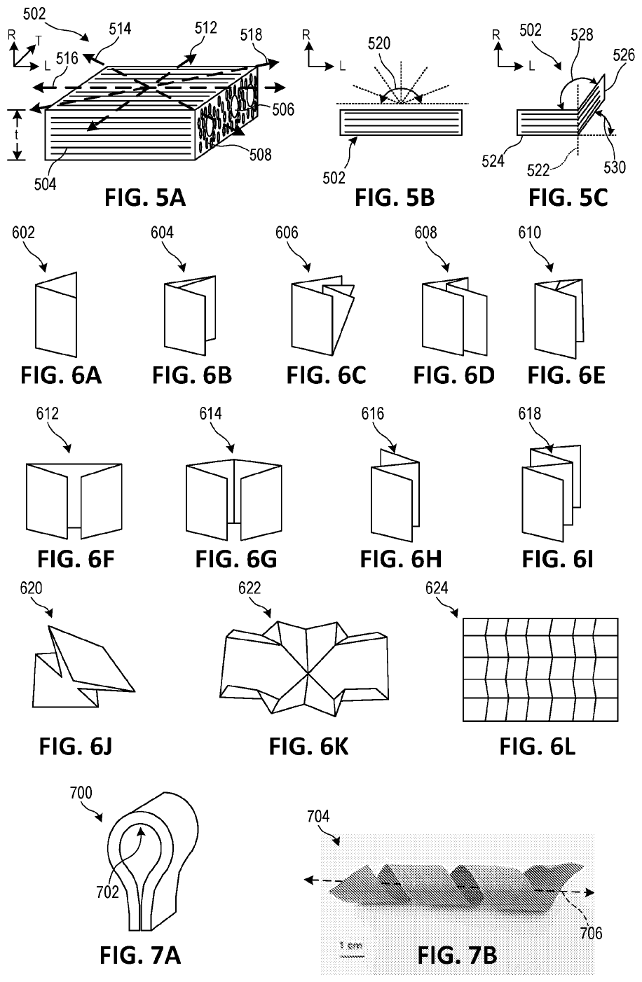

Referring to FIGS. 5A-5C, moldable, partially-delignified cellulose-based material 502 can be folded to achieve a desired 3-D configuration, after which the moldable material can be dried to set the configuration, thereby forming a rigid molded structure. For example, the microstructure of the cellulose-based material 502 can include open vessels 506 and substantially-collapsed fiber cells 508 that each extend along a longitudinal growth direction 504 of the natural plant. The cellulose-based material 502 can have a thickness, t, in a direction perpendicular to the longitudinal growth direction 504 that is less than or equal to 10 mm. The moldable material 502 can be bent or folded about any direction in a plane perpendicular to the thickness direction. The moldable material 502 can be folded or bent through an angular angle 520 that spans 180°. For example, when a first part 524 and a second part 526 of moldable material 502 are bent or folded with respect to each other about crease line 522, the material 502 can form an interior angle 528 (e.g., between the first and second parts 524, 526 of the material 502) and an exterior angle 530 (e.g., the supplementary angle to interior angle 528, formed between an original position of the bent or folded parts and a final position of the bent or folded parts), as shown in FIG. 5C. The interior angle 528 can be anywhere from 0° (e.g., the first and second parts 524, 526 being in contact) to 180°.

Although FIGS. 5B-5C illustrate folding about a crease line perpendicular to the longitudinal growth direction 504, embodiments of the disclosed subject matter are not limited thereto. Rather, as illustrated in FIG. 5A, the material 502 can be folded or bent about any direction, such as a direction 512 perpendicular to the longitudinal growth direction 504, a direction 516 parallel to the longitudinal growth direction 504, a direction 514 or 518 at a 45° angle with respect to the longitudinal growth direction 504, or any direction in between 512-518. Moreover, as long as the moldable cellulose-base material retains sufficient moisture content (e.g., ≥35 wt %), it can be folded and unfolded any number of times without breakage or deformation (e.g., fatigue-free operation).

In some embodiments, the moldable cellulose-based materials can be folded one or more times in a manner similar to paper origami or kirigami, in order to make 3-D structures. For example, FIGS. 6A-6L show various fold patterns that can be employed with the moldable cellulose-based materials, including half fold pattern 602, tri-fold pattern 604, quarter fold pattern 606, parallel fold pattern 608, roll fold pattern 610, gate fold pattern 612, double gate fold pattern 614, z-fold pattern 616, accordion fold pattern 618, stauche fold pattern 620, Turkish fold pattern 622, and miura fold pattern 624. Other fold patterns beyond those illustrated are also possible. Moreover, more complex structures for the moldable cellulose-based materials can be formed by combining basic fold patterns.

Alternatively, in some embodiments, the moldable cellulose-based materials can be bent (e.g., having a radius of curvature) to form 3-D structures. For example, FIG. 7A illustrates a moldable cellulose-based material 700 that has been bent to form an arcuate or curved portion 702 instead of a discrete crease or fold line. FIG. 7B illustrates another example, where a moldable cellulose-based material was wrapped around a rod and dried, thereby forming a molded cellulose-based material 704 in a corkscrew or helix configuration around central axis 706. In another example, a multi-layer cylinder can be made by roll forming the moldable cellulose-based material and then drying. Other more complex shapes can be formed by any combination of bend and folds. Whether bent, folded, twisted, molded, or otherwise shaped, the moldable cellulose-based materials can be converted into a rigid molded structure via drying the material in the desired configuration.

### Structural Material Examples

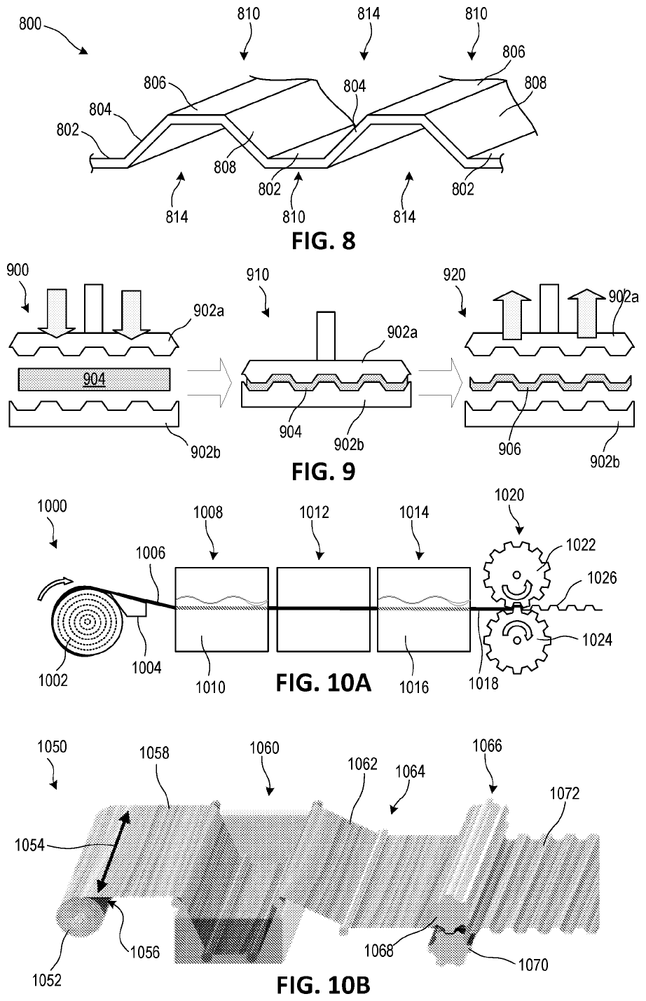

In some embodiments, the moldable cellulose-based materials can be folded, bent, or otherwise shaped into an appropriate 3-D configuration and then dried to set the configuration. Such 3-D molded cellulose-based materials can serve as a structural material or a component of a composite structural material. For example, FIG. 8 illustrates an exemplary repeating, undulating configuration for the cellulose-based material as a structural material or component thereof. The undulating or corrugated structural material 800 can be formed form a single monolithic piece of moldable cellulose-based material. After folding the moldable material to have the illustrated configuration, the moldable material can be dried to set the shape by increasing the rigidity of the material.

The undulating structural material 800 is formed of repeating pattern of top-side peak regions 810 with intervening trough regions 814. Although only two peak regions 810 and a single trough region 814 are illustrated in FIG. 8, embodiments may include any number of peak and trough regions, for each, on the order of tens, hundreds, thousands, or more regions 810, 814. Each peak region 810 is defined by an upper member 806, which may be substantially flat or planar, situated between an inclined member 804 and a declined member 808. Each trough region 814 is defined by a lower member 802, which may be substantially flat or planar, situated between a declined member 808 and an inclined member 804. The trough region 814 may be considered to share the inclined member 804 and declined member 808 with the adjacent peak regions 810. Although the upper member 806 and lower member 802 have been illustrated as substantially flat or planar, with clear delineations between the different members 802-808, practical embodiments may have rounded or blended transitions between the different members or non-planar configurations. The material 800 can be constructed such that formation of the peak region 810 on one side of the material forms a corresponding trough region on an opposite side of the material, and vice versa.

The undulating pattern illustrated in FIG. 8 can be formed by folding or bending the moldable cellulose-based material at appropriate crease lines that form the juncture of the inclined member 804 with its adjacent lower member 802 and upper member 806, and that form the juncture of the declined member 808 with its adjacent lower member 802 and upper member 806. In some embodiments, the crease line forming such junctures may extend parallel to a longitudinal growth direction of the natural plant. In such configurations, the resulting molded material can be arranged to support a load in a direction parallel to the crease lines, e.g., directly or indirectly applied to an exposed edge of members 802-808. Alternatively, in some embodiments, the crease line forming such junctures may extend perpendicular to a longitudinal growth direction of the natural plant. In such configurations, the resulting molded material can be arranged to support a load in a direction perpendicular to the creased lines, e.g., directly or indirectly applied to lower members 802 and/or upper members 806.

To form a molded cellulose-based material having the undulating pattern of FIG. 8, a batch fabrication setup employing a pressing mold can be used. For example, FIG. 9 illustrates an exemplary fabrication setup employing batch operation. For example, a moldable cellulose material 904 can be placed in the batch setup 900 (e.g., hydraulic press) between upper platen 902a and lower platen 902b of a mold with the desired undulating pattern. At pressing stage 910, the upper and lower platens can come together to press the moldable cellulose-based material 904 therebetween, thereby folding or bending the material 904 into the desired undulating pattern with corresponding crease lines. In some embodiments, the pressing stage 910 can include heating of the material 904 while being pressed, for example, by heating of one or both platens 902a, 902b, which heating may be effective to dry the material 904 within the mold. At the release stage 920, the resulting cellulose-based material 906 can be substantially rigid with the desired undulating configuration. Alternatively, in some embodiments, the pressing stage 910 can be performed without heating, but with sufficient pressure and/or duration to drive out enough moisture that the moldable material 904 between the platens 902a, 902b converts into a rigid molded structure. Alternatively, in some embodiments, the pressing stage 910 can be performed without heating, and the material released from the platens 902a, 902b at the release stage 920 may remain moldable until it can be subsequently dried. The setup illustrated in FIG. 9 can be used to form undulating patterns with fold lines at any orientation with respect to the underlying longitudinal growth direction of the cellulose-based material.

Alternatively, to form the undulating pattern of FIG. 8, a continuous fabrication setup employing roll processing can be used. For example, large wood sheets can be obtained by rotary cutting, followed by continuous processing via a first station for chemical treatment for partial delignification, a second station for drying, a third station for fluid-shock treatment, and a fourth station for molding. For example, FIG. 10A illustrate an exemplary fabrication setup 1000 employing continuous operation. Natural wood 1002 may be in the form of a log or cylindrical bar, with lumina extending in a direction perpendicular to the page. The natural wood 1002 can be continuously cut by a rotary lathe 1004, for example, to separate a thin continuous layer 1006 of natural wood for subsequent processing. The natural wood layer 1006 can be conveyed to station 1008 for the next step in the fabrication process, e.g., immersing the wood 1006 within a chemical solution 1010, for example, as described above with respect to process block 104 of method 100, to partially remove lignin from the wood. In some embodiments, the size of the station 1008 and the speed of conveyance of the wood layer 1006 through the station 1008 may correspond to the desired immersion time for the chemical treatment. Thus, a time from when a portion of the layer 1006 enters housing station 1008 to when it leaves for drying station 1012 would correspond to the immersion time for the desired amount of lignin removal.

After delignification station 1008, the partially-delignified wood may be conveyed to drying station 1012, which can apply any type of convective, conductive, or radiative heating to reduce the water content of the wood to less than or equal to 15 wt %, for example, as described above with respect to process block 110 of method 100. For example, drying station 1012 can employ forced air-drying using air heated to a temperature of ˜80° C. for about 2 minutes. After drying station 1012, the dried wood may be conveyed to fluid shock station 1014, where the wood is immersed within a fluid 1016 (e.g., water, alcohol, or a combination thereof), for example, as described above with respect to process block 112 of method 100. In particular, the fluid shock station 1014 can rehydrate the wood traversing therethrough to have a moisture content of at least 35 wt %, thereby yielding moldable wood 1018 exiting station 1014.

After fluid shock station 1014, the moldable wood 1018 can be directed to a molding station 1020, where patterned rollers 1022, 1024 are complementary-shaped to impress upon the moldable wood 1018 the desired undulating pattern, as shown at 1026. However, the setup illustrated in FIG. 10A can only be used to form fold lines extending parallel to the underlying longitudinal growth direction of the wood. In some embodiments, the upper roller 1022 and lower roller 1024, remain at a fixed distance from each other that is less than a thickness of the moldable wood 1018, thereby applying a pressing force that further densifies the wood in forming the pattern. In some embodiments, during the molding, one or both rollers 1022, 1024 can be heated so as to raise a temperature of the wood 1018 above room temperature during the molding, for example, to transition the wood from the flexible moldable state to the rigid molded state. Alternatively or additionally, the rollers 1022, 1024 may be unheated, but a separate heating mechanism may be provided, or an environment containing or following the molding station 1020 may be heated, in order to dry the moldable wood 1018 during molding station 1020 or thereafter.

FIG. 10B illustrates another exemplary fabrication setup 1050 employing continuous operation to form molded wood with the undulating pattern of FIG. 8. Natural wood 1052 may be in the form of a log or cylindrical bar, with lumina extending along direction 1054. The natural wood 1052 can be continuously cut by a rotary lathe 1056, for example, to separate a thin continuous veneer 1058 of natural wood for subsequent processing. The veneer 1058 can be conveyed to a delignification station 1060, where the veneer 1058 is immersed within a chemical solution, for example, as described above with respect to process block 104 of method 100, to partially remove lignin from the wood. In some embodiments, the size of the station 1060 and the speed of conveyance of the veneer 1058 may correspond to the desired immersion time for the chemical treatment. After delignification station 1060, the partially-delignified veneer 1062 may be conveyed to partial drying station 1064, which can apply any type of convective, conductive, or radiative heating to reduce the water content of the wood to no less than 35 wt %, for example, as described above with respect to process block 108 of method 100. For example, drying station 1064 can employ forced air-drying using air heated to a temperature of ˜80° C. for about 2 minutes.

After drying station 1064, the resulting moldable wood can be directed to a molding station 1066, where patterned rollers 1068, 1070 are complementary-shaped to impress upon the moldable wood the desired undulating pattern, as shown at 1072. However, the setup illustrated in FIG. 10B can only be used to form fold lines extending parallel to the underlying longitudinal growth direction 1054 of the wood. In some embodiments, the upper roller 1068 and lower roller 1070, remain at a fixed distance from each other that is less than a thickness of the moldable wood, thereby applying a pressing force that further densities the wood in forming the pattern. In some embodiments, during the molding, one or both rollers 1068, 1070 can be heated so as to raise a temperature of the wood above room temperature during the molding, for example, to transition the wood from the flexible moldable state to the rigid molded state. Alternatively or additionally, the rollers 1068, 1070 may be unheated, but a separate heating mechanism may be provided, or an environment containing or following the molding station 1020 may be heated, in order to dry the moldable wood 1018 during molding station 1020 or thereafter.

It should be noted that the fabrication setups of any of FIGS. 9-10B can also be adapted to fabricated molded cellulose-based materials having shape configurations other than the undulating pattern of FIG. 8. However, the illustrated undulating pattern may be especially useful in forming structural materials. In some embodiments, multiple molded cellulose-based materials having the undulating configuration can be assembled together with one or more support plates to form a regularly-arranged multilayer structure, a symmetrically-arranged multilayer structure, a honeycomb composite structure, or any other support structure.

For example, FIG. 11A illustrates a multilayer structure 1100 employing a regular arrangement of molded cellulose-based materials, for example, first molded piece 1102 and second molded piece 1104. The first molded piece 1102 can be disposed between and optionally coupled (e.g., using epoxy, glue, or other adhesive) to an upper support plate 1106 and a middle support plate 1108, and the second molded piece 1104 can be disposed between and optionally coupled (e.g., using epoxy, glue, or other adhesive) to a lower support plate 1110 and the middle support plate 1108. For example, each support plate 1106-1110 can be a metal sheet (e.g., aluminum or aluminum alloy) having a thickness of 1 mm, and each molded piece 1102, 1104 can have a thickness of 2 mm.

In the regular arrangement, the undulating patterns of the molded pieces 1102, 1104 can be aligned with respect to the thickness direction 1120, for example, where each trough 1112 of the first piece 1102 is aligned with a corresponding trough 1116 of the second piece 1104, and each peak 1114 of the first piece 1102 is aligned with a corresponding peak 1118 of the second piece 1104. In some embodiments, the cellulose-based materials of the molded pieces 1102, 1104 are arranged such that the longitudinal growth direction is parallel to the folds of the undulating pattern (e.g., perpendicular to the plane of the page). Alternatively, in some embodiments, the cellulose-based materials of the molded pieces 1102, 1104 are arranged such that the longitudinal growth direction is perpendicular to the folds of the undulating pattern (e.g., parallel to the plane of the page).

FIG. 11B illustrates another multilayer structure 1130 employing a reflectional symmetric arrangement of molded cellulose-based materials, for example, first molded piece 1132 and second molded piece 1134. The first molded piece 1132 can be disposed between and optionally coupled (e.g., using epoxy, glue, or other adhesive) to an upper support plate 1106 and a middle support plate 1108, and the second molded piece 1134 can be disposed between and optionally coupled (e.g., using epoxy, glue, or other adhesive) to a lower support plate 1110 and the middle support plate 1108. For example, each support plate 1106-1110 can be a metal sheet (e.g., aluminum or aluminum alloy) having a thickness of 1 mm, and each molded piece 1132, 1134 can have a thickness of 2 mm.

In the reflection symmetric arrangement, the undulating patterns of the molded pieces 1132, 1134 can be mirror images with respect to each other with respect to the middle support plate 1108, for example, where each trough 1142 of the first piece 1132 is aligned with a corresponding peak 1146 of the second piece 1134, and each peak 1144 of the first piece 1132 is aligned with a corresponding trough 1148 of the second piece 1134. In some embodiments, the cellulose-based materials of the molded pieces 1132, 1134 are arranged such that the longitudinal growth direction is parallel to the folds of the undulating pattern (e.g., perpendicular to the plane of the page). Alternatively, in some embodiments, the cellulose-based materials of the molded pieces 1132, 1134 are arranged such that the longitudinal growth direction is perpendicular to the folds of the undulating pattern (e.g., parallel to the plane of the page).

In FIGS. 11A-11B, the support plates are arranged parallel to the planes of the upper member of each peak region and the lower member of each trough region of the cellulose-based materials (e.g., perpendicular to the plane of the page). However, in some embodiments, the support plates can instead be arranged perpendicular to the planes of the upper member of each peak region and the lower member of each trough region of the cellulose-based materials (e.g., parallel to the plane of the page). Moreover, in FIGS. 11A-11B, support plates are disposed between adjacent molded cellulose-based pieces along the thickness direction. However, in some embodiments, adjacent molded cellulose-based materials can be directly coupled to each other without an intervening plate or member.

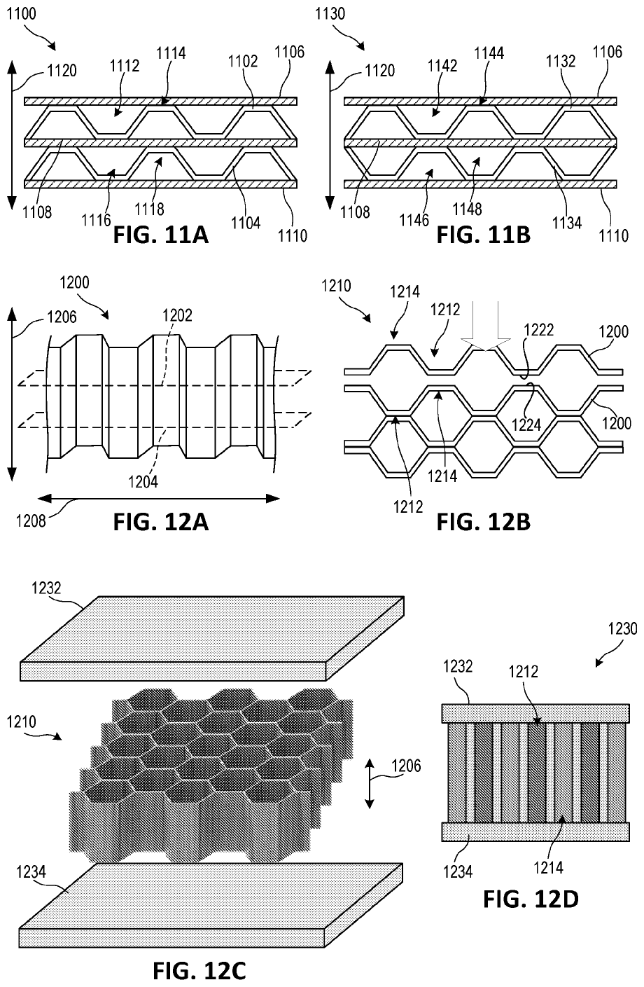

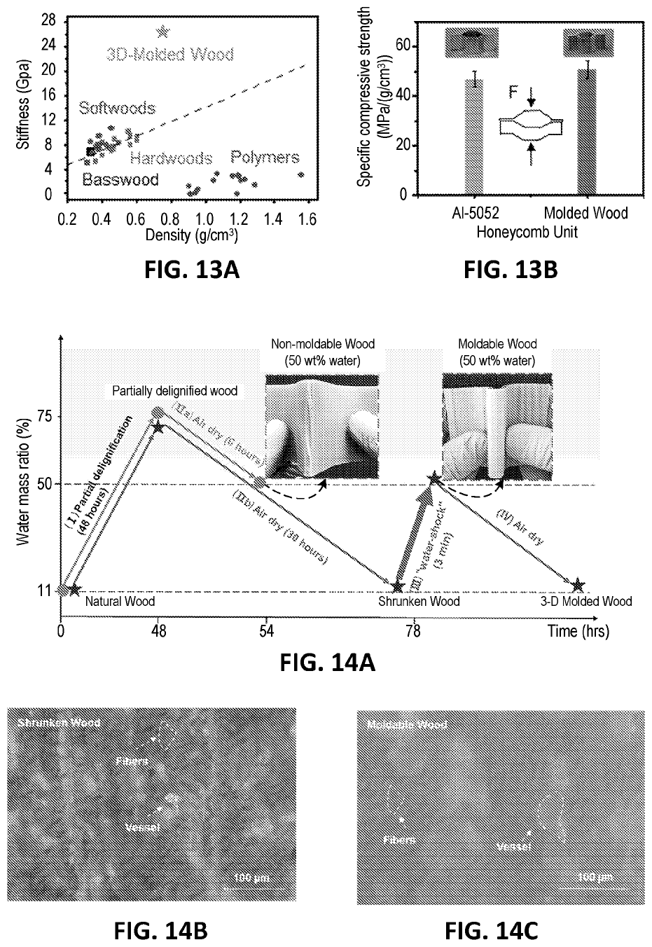

For example, FIGS. 12A-12D illustrate a configuration where adjacent molded cellulose-based materials are coupled directly to each other to form a honeycomb (e.g., hexagonal pattern) core 1210 and where support plates 1232, 1234 are arranged perpendicular to the planes of the upper member of each peak region 1214 and the lower member of each trough region 1212 of the cellulose-based materials 1200. For example, each molded cellulose-based material 1200 can be constructed using the continuous setup of FIG. 10B. Since the size of the molded material generated by the continuous setup may be larger than a desired thickness for the structural composite, the molded material 1200 can be cut into separate pieces at one or more cut planes 1202, 1204. Using the continuous setup of FIG. 10B, the longitudinal growth direction (and the extension direction of longitudinal cells in the material) will be parallel to the crease lines, e.g., along direction 1206 in FIG. 12A. Alternatively, in some embodiments, the cellulose-based material can be fabricated with the longitudinal growth direction being perpendicular to the crease lines, e.g., along direction 1208 in FIG. 12A, for example, using the batch processing setup of FIG. 9.

The honeycomb core 1210 for the composite structure 1230 can be formed by disposing multiple molded cellulose-based materials 1200 adjacent to each other in reflection symmetric arrangement, as shown in FIG. 12B. Epoxy adhesive on facing surfaces 1222, 1224 of the trough 1212 and peak 1214 can couple adjacent materials 1200 together. Once the honeycomb core 1210 is assembled, it can be arranged between top support plate 1232 and bottom support plate 1234, as shown in FIGS. 12C-12D. Epoxy adhesive between the honeycomb core 1210 and the facing surfaces of the support plates 1232, 1234 can couple the support plates 1232, 1234 to the core 1210. The resulting composite structure 1230 can have a load applied between the support plates 1232-1234 along direction 1206 so as to be parallel to a direction of extension of cellulose fibers within each molded cellulose-based material 1200 forming the core 1210.

In some embodiments, one or both of support plates 1232-1234 can be formed of a non-cellulose-based material, such as metal, metal alloy, ceramic, glass, composite, polymer, etc. For example, each support plate 1232-1234 can be a metal sheet (e.g., aluminum or aluminum alloy) having a thickness of 1 mm, and the honeycomb core 1210 can have a thickness of 2 mm. Alternatively, in some embodiments, one or both of support plates 1232-1234 can be formed of a cellulose-based material, which may be the same or different than the material forming the molded materials of the honeycomb core. Although FIGS. 12A-12C illustrate a hexagonal shape formed by the undulating pattern of the assembled molded materials, embodiments of the disclosed subject matter are not limited thereto. Rather, the repeating shape within the honeycomb core can be any geometric shape by appropriate adjustment of the undulating pattern, for example, a triangular shape, a rectangular shape, a diamond shape, an oval shape, or any other shape.

### FABRICATED EXAMPLES AND EXPERIMENTAL RESULTS

### First Example—Oak

In a first example, oak was used as a raw material. After partial delignification, drying, and fluid shock, the moldable oak was shaped to have a curved geometry and subsequently dried to form a rigid molded structure. The curved wood has high mechanical strength, low curvature, as well as low density. In particular, the resultant curved wood exhibits an enhanced tensile strength of 345 MPa, which is 3 times greater than traditional wood bent by stream pretreatment. Meanwhile, the specific strength of the curved wood increase from 135 to 318 MPa·cm³/g.

### Second Example—Basswood

In a second example, basswood was used to fabricate a 3D-molded wood. First, a natural wood sheet (basswood, typical sample dimensions: 3.18 mm×30 cm×20 cm) was treated with a boiling aqueous solution of 2.5 M NaOH and 0.4 M Na₂SO₃ for 2 days, followed by immersion in water several times to remove the chemicals. Next, the partially delignified wood was air dried at room temperature for 30 hours to form a dried wood intermediate, which was then immersed in water for 3 min (i.e., the “fluid-shock” process) to form moldable. Finally, the 3D-molded wood was achieved by shaping the moldable wood into a desired structure and removing water from the material by air-drying at room temperature for 30 hours. The 3D-molded wood demonstrated improved mechanical properties for lightweight structural applications, including a tensile strength of ˜300 MPa and compressive strength of 60 MPa along the wood fiber direction, which are 6- and 2-times higher than that of the raw natural wood, respectively. The improved mechanical properties of the 3D-molded wood are due to its denser structure, which features highly packed intertwined cell walls at the microscale and well-aligned cellulose nanofibrils inside the cell walls at the nanoscale. Additionally, the strength and specific stiffness of the 3D-molded wood are even higher than that of Al-5052. Given its light weight, with a low density of 0.75 g/cm³, the 3D-molded wood has a high specific tensile strength of 386.8 MPa/(g/cm³), which is ˜5-times greater than that of Al-5052 (84.4 MPa/(g/cm³)). Furthermore, as shown in an Ashby plot of material stiffness versus density in FIG. 13A, the specific stiffness of 3D-molded wood exceeds that of a range of hardwoods, softwoods, and polymers, suggesting its potential as a structural material.

### Third Example—Composite Structure

The low density, high mechanical strength, and excellent formability of the 3D-molded wood offers broad versatility in designing and manufacturing large, lightweight, load-bearing designs, such as honeycomb structures, which are conventionally made of polymers or metals such as the Al-5052 alloy. 3D-molded wood honeycomb structures were molded along the wood fiber direction. The 3D-molded wood honeycomb unit demonstrates comparable specific compressive strength (51.6 MPa/(g/cm³)) as the Al-5052 honeycomb unit (46.8 MPa/(g/cm³)), as shown in FIG. 13B.

To evaluate the compressive and bending properties of the assembled 3D-molded wood honeycomb core, the core was sandwiched between two aluminum plates to from a composite structure. The composite structure demonstrated a compressive strength of 9.1 MPa and specific compressive strength of 91.0 MPa/(g/cm³) (based on a density of 0.1 g/cm3), which is higher than that of the Al-5052 honeycomb structure. To further demonstrate the material's capabilities, the composite structure was used to support the weight of a 1588 kg car, which corresponds to 1526-times the weight of the 3D-molded wood honeycomb core itself. To demonstrate scalability, an example of 3D-molded wood honeycomb core was fabricated with dimensions of 80 cm×6 cm×1.5 cm.

Comparing the molded and moldable wood to other structural materials, the molded/moldable wood can exhibit superior mechanical properties. In terms of load bearing capability, both the molded wood and Al alloy honeycomb units (e.g., 1.5 cm in height, 2 cm in width, 4.4 cm in length; weight of 1.3 g and 3.1 g, respectively; density of 0.10 g/cm³ and 0.23 g/cm³, respectively) can support 100-200 lbs. without structural deformation or destruction. Paper honeycomb units, however, are easily destroyed by such weight. In addition, the molded wood honeycomb unit demonstrates the highest specific compressive strength (51.6 MPa/(g/cm³)), far higher than that of paper honeycomb units (2.1 MPa/(g/cm³)) and higher than that of Al-5052 honeycomb units (46.8 MPa/(g/cm³)). In terms of foldability, the fold-unfold cycles prior to tearing or fracture for paper, Al-5052, and moldable wood are 10 times, 3 times and over 100 times, respectively, which confirms the superior flexible nature of the moldable wood material.

### Fourth Example—Cell Wall Structure

FIG. 14A is a schematic demonstrating the fabrication process from natural wood to 3D-molded wood. To fabricate 3D-molded wood, natural wood was first delignified to partially remove the brittle lignin component of the wood cell walls, then completely air dried over a period of 30 hours. The drying caused the cell walls to shrink, closing both large and small channels (e.g., vessels and fibers, respectively) to obtain a shrunken wood intermediate, as shown in FIG. 14B. The shrunken wood is then “shocked” by briefly soaking (e.g., 3 minutes) the wood in water to obtain moldable wood. The moldable wood has a unique cell wall structure in which the vessels and fibers become “wrinkled” upon swelling, as shown in FIG. 14C. The moldable wood can be folded and molded into arbitrary shapes that can then be locked in place by drying the material for a final time to obtain the 3D-molded wood product.

As a control, natural wood was partially delignified using the same procedure, but then the control material was air-dried for just 6 hours, without any water shock treatment, to reach a 50 wt % water content, which was the same water content as that of the moldable wood. The resulting control did not feature a wrinkled cell wall structure, instead demonstrating a similar open cell microstructure as the natural wood but with thinner and more separated cell walls due to the partial removal of the lignin. Despite having the same moisture content as moldable wood, the control (referred to as non-moldable wood) lacks flexibility, instead breaking when it is bent due to the lack of a wrinkled cell wall structure. In addition, control experiments showed that dry natural wood (without space shrinkage and water lubricant), wet natural wood (without space shrinkage), the wet delignified wood (without space shrinkage), and the shrunken wood (without water lubricant) all had inferior foldability due to the absence of space shrinkage and/or water lubricant.

Simulations were conducted to further investigate how the wrinkled cell wall structure enables the release of mechanical stress during folding to prevent the material from breaking. Fiber-scale mechanics modeling shows the strain level in all cell walls of the moldable wood is extremely low (with a maximum principal tensile strain of 0.47% and compressive strain of 2.66%) even when the moldable wood is subjected to a 60% nominal strain deformation (tensile or compressive). In contrast, the maximum principal tensile strain in the cell walls of the non-moldable wood is as high as 2.3% under an overall elongation of 12.5%, significantly higher than that in the moldable wood. Despite both materials undergoing the delignification process, the fibers and vessels are open and only in loose contact in the mon-moldable wood, while the cell structures are more closed and in greater contact in the wrinkled cell walls of the moldable wood due to the drying/water-shock process. As a result, the moldable wood features sufficient hydrogen bonding among the cell walls to resist delamination during folding, while the non-moldable wood readily fractures.

### Fifth Example—Hole Formation

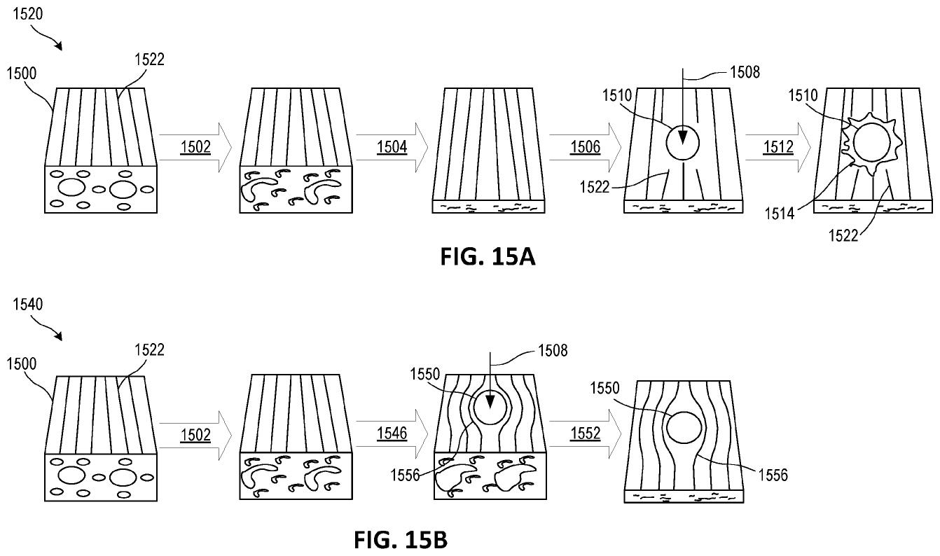

Basswood was cut into blocks 1500, each having a size of 5 cm length×5 cm width×5 mm thickness. Each wood block 1500 was subjected to a chemical treatment 1502, in particular, immersion in a solution of NaOH (2.5 mol L⁻¹) and Na₂SQ₃ (0.4 mol L⁻¹) for 12 hours, so as to partially remove lignin and hemicellulose therefrom. In a comparative example 1520 of FIG. 15A, the partially delignified wood block is then subjected to hot pressing 1504 followed by pushing or insertion 1506 of a 2 mm nail 1508 (e.g., or another sharp-tip elongated member, such as a needle) through the delignified block to form a hole 1510. However, in the resulting structure 1512, the cellulose fibers 1522 within the block can be broken at the edge 1514 of the nail hole 1510.

In contrast, in example 1540 of FIG. 15B, the partially delignified block is maintained in a moldable form (e.g., by drying and then rehydrating via fluid shock; by partially, but not fully, drying; or by not drying the block prior to nail insertion 1546. The 2 mm nail 1546 can thus be inserted into the wood in a wet state, such that the cellulose fibers 1556 exhibit sufficient motility to deflect around the edge of hole 1550 without otherwise breaking. The diameter of the nail hole 1550 was then fixed by hot pressing the block for 24 hours. For the resulting structure 1552, the thickness of the wood reduces to ⅕ of the natural wood block 1500, and the densified wood can exhibit mechanical properties similar to densified wood after 1504 prior to any hold formation. Yet, resulting structure 1552 can also avoid breakage of cellulose fibers at the edge of hole 1550.

### Additional Examples of the Disclosed Technology

In view of the above described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.

Clause 1. A method comprising:

(a) producing a piece of partially-delignified wood by subjecting a piece of natural wood to one or more chemical treatments so as to remove at least some lignin therefrom while preserving a microstructure of the piece of natural wood, the microstructure comprising cellulose-based longitudinal cells extending along an extension direction that is substantially parallel to a longitudinal growth direction of the natural wood;

(b) drying the piece of partially-delignified wood so as to remove moisture therefrom, such that lumina of at least some of the cellulose-based longitudinal cells collapse and such that the dried piece has a moisture content less than or equal to 15 wt %;

(c) performing a fluid-shock treatment to the dried piece of partially-delignified wood to yield a rehydrated piece of partially-delignified wood, the fluid-shock treatment comprising exposing the dried piece to moisture, the rehydrated piece having a moisture content of at least 35 wt %; and

(d) forming the rehydrated piece of partially-delignified wood from a substantially flat planar configuration into a non-planar three-dimensional configuration,

wherein the lumina of first cellulose-based longitudinal cells in the rehydrated piece of partially-delignified wood that have a cross-sectional size less than a first size are substantially collapsed and lumina of second cellulose-based longitudinal cells in the rehydrated piece of partially-delignified wood that have a cross-sectional size greater than the first size are at least partially open.

Clause 2. The method of any clause or example herein, in particular Clause 1, wherein a thickness of the piece of natural wood in a direction perpendicular to the extension direction is 10 mm or less (e.g., ≤4 mm).
Clause 3. The method of any clause or example herein, in particular any one of Clauses 1-2, wherein the moisture content of the rehydrated piece during (d) is at least 50 wt %.
Clause 4. A method comprising:

(a) producing a piece of partially-delignified wood by subjecting a piece of natural wood to one or more chemical treatments so as to remove at least some lignin therefrom while preserving a microstructure of the piece of natural wood, the microstructure comprising cellulose-based longitudinal cells extending along an extension direction that is substantially parallel to a longitudinal growth direction of the natural wood;

(b) partially drying the piece of partially-delignified wood so as to remove some moisture therefrom, the partially-dried piece of partially-delignified wood having a moisture content of at least 35%; and

(c) forming the partially-dried piece of partially-delignified wood from a substantially flat planar configuration into a non-planar three-dimensional configuration, wherein lumina of first cellulose-based longitudinal cells in the partially-dried piece of partially-delignified wood that have a cross-sectional size less than a first size are substantially collapsed and lumina of second cellulose-based longitudinal cells in the partially-dried piece of partially-delignified wood that have a cross-sectional size greater than the first size are at least partially open.

Clause 5. The method of any clause or example herein, in particular any one of Clauses 1-4, wherein a thickness of the piece of natural wood in a direction perpendicular to the extension direction is between 0.1 mm and 10 mm, inclusive (e.g., ≥0.5 mm and ≤10 mm).
Clause 6. The method of any clause or example herein, in particular any one of Clauses 1-5, wherein the forming into the non-planar three-dimensional configuration comprises folding the piece, bending the piece, or any combination thereof.
Clause 7. The method of any clause or example herein, in particular any one of Clauses 1-6, further comprising, after the forming into the non-planar three-dimensional configuration:

(e) drying the piece to remove moisture therefrom so as to set a shape of the piece and form a rigid monolithic piece of partially-delignified wood in the non-planar three-dimensional configuration,

wherein the rigid monolithic piece has a moisture content less than or equal to 15 wt %.

Clause 8. The method any clause or example herein, in particular Clause 7, further comprising, prior to (e):

forming at least one hole or opening that extends through a thickness of the piece of partially-delignified wood having the moisture content of at least 35 wt %,

wherein the forming comprises a non-machining technique.

Clause 9. The method of any clause or example herein, in particular any one of Clauses 1-8, further comprising, after (a) and prior to (b):

forming at least one hole or opening that extends through a thickness of the piece of partially-delignified wood,

wherein the forming comprises a non-machining technique.

Clause 10. The method of any clause or example herein, in particular Clause 9, wherein the forming at least one hole or opening comprises pushing or inserting a needle, nail, or other sharp-tip elongated member into the piece.
Clause 11. The method of any clause or example herein, in particular any one of Clauses 7-10, wherein the drying of (e) comprises exposing to an air or gas flow, exposing to a stagnant volume of air or gas, exposing to vacuum, exposing to room temperature, heating to a temperature above room temperature, or any combination thereof.
Clause 12. The method of any clause or example herein, in particular any one of Clauses 7-11, further comprising:

forming a protective layer or coating over the rigid monolithic piece, the protective layer or coating being constructed to prevent rehydration of the rigid monolithic piece.

Clause 13. The method of any clause or example herein, in particular any one of Clauses 7-12, further comprising:

assembling the rigid monolithic piece of partially-delignified wood with one or more other rigid monolithic pieces of partially-delignified wood;

assembling the rigid monolithic piece of partially-delignified wood with one or more other pieces of wood;

assembling the rigid monolithic piece of partially-delignified wood with one or more other pieces of a non-wood material (e.g., polymer, metal, metal alloy, cement, glass, ceramic, etc.) to form a composite structure; or

any combination of the above.

Clause 14. The method of any clause or example herein, in particular any one of Clauses 1-13, wherein the exposing to moisture of (c) comprises immersing partially or fully within a fluid, exposing to fluid vapor in a humidified environment, or any combination thereof.
Clause 15. The method of any clause or example herein, in particular any one of Clauses 4-14, wherein the moisture content of the partially-dried piece during (c) is at least 50 wt %.
Clause 16. The method of any clause or example herein, in particular any one of Clauses 1-15, wherein the natural wood comprises a hardwood, the first cellulose-based longitudinal cells comprise fibers or tracheids of the hardwood, and the second cellulose-based longitudinal cells comprise vessels of the hardwood.
Clause 17. The method of any clause or example herein, in particular any one of Clauses 1-15, wherein the natural wood comprises a softwood, and the first and second cellulose-based longitudinal cells comprise tracheids.
Clause 18. The method of any clause or example herein, in particular any one of Clauses 1-17, wherein for each lumen of the second cellulose-based longitudinal cells, a cross-sectional size thereof after the drying of (b) is less than a cross-sectional size thereof in the natural wood prior to (a).
Clause 19. The method of any clause or example herein, in particular any one of Clauses 1-18, wherein:

the subjecting to one or more chemical treatments of (a) is such that between 0.1% and 99%, inclusive, of the lignin in the natural wood is removed therefrom to produce the piece of partially-delignified wood;

the subjecting to one or more chemical treatments of (a) is such that between 0.1% and 99%, inclusive, of hemicellulose in the natural wood is removed therefrom to produce the piece of partially-delignified wood; or

any combination of the above.

Clause 20. The method of any clause or example herein, in particular any one of Clauses 1-19, wherein:

the subjecting to one or more chemical treatments of (a) is such that 50% or less of the lignin in the natural wood is removed therefrom to produce the piece of partially-delignified wood;

the subjecting to one or more chemical treatments of (a) is such that 50% or less of the hemicellulose in the natural wood is removed therefrom to produce the piece of partially-delignified wood; or

any combination of the above.

Clause 21. The method of any clause or example herein, in particular any one of Clauses 1-20, wherein:

the subjecting to one or more chemical treatments of (a) is such that a lignin content in the natural wood is reduced by no more than 10% to produce the piece of partially-delignified wood;

the subjecting to one or more chemical treatments of (a) is such that hemicellulose content in the natural wood is reduced by no more than 10% to produce the piece of partially-delignified wood; or

any combination of the above.

Clause 22. The method of any clause or example herein, in particular any one of Clauses 1-21, wherein:

the natural wood is a hardwood, and an amount of lignin in the piece of partially-delignified wood after (a) is at least 10 wt %; or

the natural wood is a softwood, and an amount of lignin in the piece of partially-delignified wood after (a) is at least 12.5 wt %.

Clause 23. The method of any clause or example herein, in particular any one of Clauses 1-22, wherein at least one of the one or more chemical treatments comprises partial or full immersion in one or more chemical solutions.
Clause 24. The method of any clause or example herein, in particular Clause 23, wherein the one or more chemical solutions comprise an alkaline solution.
Clause 25. The method of any clause or example herein, in particular any one of Clauses 23-24, wherein the one or more chemical solutions comprise sodium hydroxide (NaOH), lithium hydroxide (LiOH), potassium hydroxide (KOH), sodium sulfite (Na₂SO₃), sodium sulfate (Na₂SO₄), sodium sulfide (Na₂S), NaₙS wherein n is an integer, urea (CH₄N₂O), sodium bisulfite (NaHSO₃), sulfur dioxide (SO₂), anthraquinone (C₁₄H₈O₂), methanol (CH₃OH), ethanol (C₂H₅OH), butanol (C₄H₉OH), formic acid (CH₂O₂), hydrogen peroxide (H₂O₂), acetic acid (CH₃COOH), butyric acid (C₄H₈O₂), peroxyformic acid (CH₂O₃), peroxyacetic acid (C₂H₄O₃), ammonia (NH₃), tosylic acid (p-TsOH), sodium hypochlorite (NaClO), sodium chlorite (NaClO₂), chlorine dioxide (ClO₂), chorine (Cl₂), or any combination of the above.
Clause 26. The method of any clause or example herein, in particular any one of Clauses 23-25, wherein the one or more chemical solutions comprise a boiling solution of NaOH and Na₂SO₃.
Clause 27. The method of any clause or example herein, in particular any one of Clauses 1-26, further comprising, prior to (a), cutting a substantially-cylindrical portion of natural wood using a roll-cutting technique to form the piece of natural wood as a veneer.
Clause 28. A moldable wood structure formed by the method of any clause or example herein, in particular any one of Clauses 1-27.
Clause 29. A rigid molded wood structure formed by the method of any clause or example herein, in particular any one of Clauses 1-27.
Clause 30. A structural material comprising:

at least two dried monolithic pieces of partially-delignified wood, each dried monolithic piece being formed to have repeating, undulating configuration formed by multiple folds or bends therein, the undulating configuration having a repeating pattern with at least one peak and at least one trough, each dried monolithic piece having a moisture content less than or equal to 15 wt %; and

first and second support plates coupled to the at least two dried monolithic pieces.

Clause 31. The structural material of any clause or example herein, in particular Clause 30, wherein the folds or bends in the undulating configuration are about respective axes parallel to a first direction, and the support plates are disposed on opposite sides of the dried monolithic pieces with respect to the first direction so as to sandwich the monolithic pieces therebetween, and the structural material has a honeycomb configuration.
Clause 32. The structural material of any clause or example herein, in particular any one of
Clauses 30-31, wherein facing surfaces of adjacent ones of the at least two dried monolithic pieces are coupled together.
Clause 33. The structural material of any clause or example herein, in particular any one of Clauses 30-32, wherein each dried monolithic piece has a density less than 1.5 g/cm³ (e.g., ≤1 g/cm³), a tensile strength of at least 140 MPa (e.g., ≥200 MPa), a compressive strength of at least 40 MPa, a specific tensile strength of at least 115 MPa/(g/cm³) (e.g., ≥300 MPa/(g/cm³)), or any combination of the above
Clause 34. The structural material of any clause or example herein, in particular any one of Clauses 30-33, wherein the structural material has a compressive strength of at least 3 MPa (e.g., ≥5 MPa), a specific compressive strength of at least 30 MPa/(g/cm³) (e.g., ≥50 MPa/(g/cm³)), or any combination of the above.
Clause 35. The structural material of any clause or example herein, in particular any one of Clauses 30-34, wherein each dried monolithic piece has multiple peaks and troughs.
Clause 36. The structural material of any clause or example herein, in particular any one of Clauses 30-35, wherein each dried monolithic piece is in contact with both of the first and second support plates.
Clause 37. The structural material of any clause or example herein, in particular any one of Clauses 30-36, wherein one or both of the support plates comprises another dried piece of partially-delignified natural wood having a substantially flat planar configuration.
Clause 38. The structural material of any clause or example herein, in particular any one of Clauses 30-37, wherein one or both of the first and second support plates are formed of one or more non-wood materials (e.g., polymer, metal, metal alloy, cement, glass, ceramic, composite, or any combination thereof).
Clause 39. The structural material of any clause or example herein, in particular any one of Clauses 30-38, wherein the structural material is sealed so as to prevent moisture from infiltrating the at least two dried monolithic pieces.
Clause 40. The structural material of any clause or example herein, in particular any one of Clauses 30-39, further comprising:

a protective layer or coating formed on external surfaces of the at least two dried monolithic pieces,

wherein the at least two dried monolithic pieces are sealed against moisture infiltration by the protective layer or coating.

Clause 41. The structural material of any clause or example herein, in particular any one of Clauses 30-40, further comprising:

a third support plate,

wherein the folds or bends in the undulating configuration are about respective axes parallel to a first direction,

the first and second support plates are disposed on opposite sides of a first one of the dried monolithic pieces with respect to a second direction substantially perpendicular to the first direction, and

the second and third support plates are disposed on opposite sides of a second one of the dried monolithic pieces with respect to the second direction.

Clause 42. The structural material of any clause or example herein, in particular any one of Clauses 30-41, wherein a peak portion of the undulating configuration of the first one of the dried monolithic pieces is substantially aligned in a side view with a corresponding peak portion of the undulating configuration of the second one of the dried monolithic pieces.
Clause 43. The structural material of any clause or example herein, in particular any one of Clauses 30-41, wherein a peak portion of the undulating configuration of the first one of the dried monolithic pieces is substantially aligned in a side view with a corresponding trough portion of the undulating configuration of the second one of the dried monolithic pieces.
Clause 44. The structural material of any clause or example herein, in particular any one of Clauses 30-43, wherein a microstructure of each dried monolithic piece of partially-delignified wood has cellulose-based longitudinal cells of the wood that are substantially collapsed, each longitudinal cell extending along an extension direction that is substantially parallel to a longitudinal growth direction of the natural wood.
Clause 45. The structural material of any clause or example herein, in particular any one of Clauses 30-44, wherein cellulose nanofibers forming walls of the collapsed longitudinal cells in each monolithic piece of partially-delignified wood extend substantially parallel to the extension direction.
Clause 46. The structural material of any clause or example herein, in particular any one of Clauses 30-45, wherein the wood for the at least two dried monolithic pieces comprises a hardwood or a softwood.
Clause 47. The structural material of any clause or example herein, in particular any one of Clauses 30-46, wherein:

each of the at least two dried monolithic pieces of partially-delignified wood is produced by reducing a lignin content in a respective piece of natural wood by between 0.1% and 99%, inclusive;

each of the at least two dried monolithic pieces of partially-delignified wood is produced by reducing a hemicellulose content in a respective piece of natural wood by between 0.1% and 99%, inclusive; or any combination of the above.

Clause 48. The structural material of any clause or example herein, in particular any one of Clauses 30-47, wherein:

each of the at least two dried monolithic pieces of partially-delignified wood is produced by reducing a lignin content in a respective piece of natural wood by 50% or less;

each of the at least two dried monolithic pieces of partially-delignified wood is produced by reducing a hemicellulose content in a respective piece of natural wood by 50% or less; or

any combination of the above.

Clause 49. The structural material of any clause or example herein, in particular any one of Clauses 30-48, wherein:

each of the at least two dried monolithic pieces of partially-delignified wood is produced by reducing a lignin content in a respective piece of natural wood by no more than 10%;

each of the at least two dried monolithic pieces of partially-delignified wood is produced by reducing a hemicellulose content in a respective piece of natural wood by no more than 10%; or any combination of the above.

Clause 50. The structural material of any clause or example herein, in particular any one of Clauses 30-49, wherein an amount of lignin in each dried monolithic piece of partially-delignified wood is at least 10 wt %.
Clause 51. A moldable wood structure comprising:

a monolithic piece of partially-delignified natural wood having a moisture content of at least 35 wt %,

wherein the monolithic piece has a microstructure where lumina of first cellulose-based longitudinal cells of the natural wood, which have a cross-sectional size less than a first size, are substantially collapsed and lumina of second cellulose-based longitudinal cells of the natural wood, which have a cross-sectional size greater than the first size, are at least partially open, and

the cellulose-based longitudinal cells extend along an extension direction that is substantially parallel to a longitudinal growth direction of the natural wood.

Clause 52. The wood structure of any clause or example herein, in particular Clause 51, wherein the moisture content is at least 50 wt %.
Clause 53. The wood structure of any clause or example herein, in particular any one of Clauses 51-52, wherein for each lumen of the second cellulose-based longitudinal cells, a cross-sectional size thereof in the monolithic piece is less than a cross-sectional size thereof in the natural wood prior to the partial delignification.
Clause 54. The wood structure of any clause or example herein, in particular any one of Clauses 51-53, wherein the monolithic piece is constructed to be elastically deformed by bending or folding thereof within an angular range of 0° to 180°, inclusive.
Clause 55. The wood structure of any clause or example herein, in particular any one of Clauses 51-54, wherein the monolithic piece is capable of fatigue-free elastic deformation over at least 100 folding cycles.
Clause 56. A molded wood structure comprising:

the moldable wood structure of any clause or example herein, in particular any one of Clauses 51-55, formed into a non-planar three-dimensional configuration and subsequently dried to remove moisture therefrom, so as to have a moisture content less than or equal to 15 wt %.

Clause 57. The wood structure of any clause or example herein, in particular Clause 56, wherein the non-planar three-dimensional configuration comprises an origami-folded geometry or kirigami-folded geometry for the monolithic piece.
Clause 58. A molded wood structure comprising:

a dried monolithic piece of partially-delignified natural wood formed into a non-planar three-dimensional configuration, the dried monolithic piece having a moisture content less than or equal to 15 wt %,

wherein a microstructure of the dried monolithic piece has lumina of cellulose-based longitudinal cells of the wood that are substantially collapsed, each longitudinal cell extending along an extension direction that is substantially parallel to a longitudinal growth direction of the natural wood.

Clause 59. The wood structure of any clause or example herein, in particular any one of Clauses 56-58, wherein the non-planar three-dimensional geometry comprises at least two bends or folds of the monolithic piece.
Clause 60. The wood structure of any clause or example herein, in particular Clause 59, wherein a thickness of the monolithic piece at the at least two bends or folds is substantially the same as an unbent or unfolded portion of the monolithic piece.
Clause 61. The wood structure of any clause or example herein, in particular any one of Clauses 59-60, wherein at least one of the bends or folds is about an axis substantially parallel to the extension direction.
Clause 62. The wood structure of any clause or example herein, in particular any one of Clauses 59-61, wherein at least one of the bends or folds forms an interior angle less than 180°
Clause 63. The wood structure of any clause or example herein, in particular any one of Clauses 59-62, wherein at least one of the bend or folds forms an interior angle less than or equal to 135°.
Clause 64. The wood structure of any clause or example herein, in particular any one of Clauses 59-63, wherein:

at least one of the bends or folds is about an axis crossing the extension direction;

at least one of the bends or folds is about an axis parallel to the extension direction; or

any combination of the above.

Clause 65. The wood structure of any clause or example herein, in particular any one of Clauses 56-64, wherein the dried monolithic piece is constructed to be plastically deformed by folding or bending thereof.
Clause 66. The wood structure of any clause or example herein, in particular any one of Clauses 51-65, further comprising a protective layer or coating over external surfaces of the dried monolithic piece, the protective layer or coating preventing moisture infiltration into the monolithic piece.
Clause 67. The wood structure of any clause or example herein, in particular any one of Clauses 51-66, wherein the natural wood comprises a hardwood or a softwood.
Clause 68. The wood structure of any clause or example herein, in particular any one of Clauses 51-67, wherein the natural wood comprises a hardwood, the first cellulose-based longitudinal cells comprise fibers or tracheids of the hardwood, and the second cellulose-based longitudinal cells comprise vessels of the hardwood.
Clause 69. The wood structure of any clause or example herein, in particular any one of Clauses 51-67, wherein the natural wood comprises a softwood, and the first and second cellulose-based longitudinal cells comprise tracheids.
Clause 70. The wood structure of any clause or example herein, in particular any one of Clauses 51-69, wherein:

the monolithic piece is produced by reducing a lignin content in the natural wood by between 0.1% and 99%;

the monolithic piece is produced by reducing a lignin content in the natural wood by between 0.1% and 99%; or

any combination of the above.

Clause 71. The wood structure of any clause or example herein, in particular any one of Clauses 51-70, wherein:

the monolithic piece is produced by reducing a lignin content in the natural wood by 50% or less;

the monolithic piece is produced by reducing a lignin content in the natural wood by 50% or less; or

any combination of the above.

Clause 72. The wood structure of any clause or example herein, in particular any one of Clauses 51-71, wherein:

the monolithic piece is produced by reducing a lignin content in the natural wood by no more than 10%;

the monolithic piece is produced by reducing a lignin content in the natural wood by no more than 10%; or

any combination of the above.

Clause 73. The wood structure of any clause or example herein, in particular any one of Clauses 51-72, wherein an amount of lignin in the monolithic piece is at least 10 wt %.
Clause 74. The wood structure of any clause or example herein, in particular any one of Clauses 51-73, wherein:

the monolithic piece has a thickness of at least 0.1 mm (e.g., ≥0.5 mm),

the monolithic piece has a thickness of 10 mm or less, or

the monolithic piece has a thickness between 0.1 mm and 10 mm, inclusive (e.g., ≥0.5 mm and ≤10 mm).

Clause 75. The wood structure of any clause or example herein, in particular Clause 74, wherein the thickness of the monolithic piece is along a direction substantially perpendicular to the extension direction.
Clause 76. The wood structure of any clause or example herein, in particular any one of Clauses 74-75, wherein the monolithic piece has first and second dimensions in a plane perpendicular to a direction of the thickness, the first and second dimensions are orthogonal to each other, and at least one of the first and second dimensions is at least ten times greater than the thickness.
Clause 77. The wood structure of any clause or example herein, in particular any one of Clauses 51-76, wherein cellulose nanofibers forming walls of the longitudinal cells in the monolithic piece extend substantially parallel to the extension direction.
Clause 78. A method comprising:

(a) producing a piece of partially-delignified cellulose-based material by subjecting a piece of naturally-occurring cellulose-based material to one or more chemical treatments so as to remove at least some lignin therefrom while preserving a microstructure of the piece of naturally-occurring cellulose-based material, the microstructure comprising cellulose-based longitudinal cells extending along an extension direction that is substantially parallel to a longitudinal growth direction of the naturally-occurring cellulose-based material;

(b) drying the piece of partially-delignified cellulose-based material so as to remove moisture therefrom, such that lumina of at least some of the cellulose-based longitudinal cells collapse and such that the dried piece has a moisture content less than or equal to 15 wt %;

(c) performing a fluid-shock treatment to the dried piece of partially-delignified cellulose-based material to yield a rehydrated piece of partially-delignified cellulose-based material, the fluid-shock treatment comprising exposing the dried piece to moisture, the rehydrated piece having a moisture content of at least 35 wt %; and

(d) forming the rehydrated piece of partially-delignified cellulose-based material from a substantially flat planar configuration into a non-planar three-dimensional configuration,

wherein the lumina of first cellulose-based longitudinal cells in the rehydrated piece of partially-delignified cellulose-based material that have a cross-sectional size less than a first size are substantially collapsed and lumina of second cellulose-based longitudinal cells in the rehydrated piece of partially-delignified cellulose-based material that have a cross-sectional size greater than the first size are at least partially open.

Clause 79. The method of any clause or example herein, in particular Clause 78, wherein the moisture content of the rehydrated piece during (d) is at least 50 wt %.
Clause 80. A method comprising:

(a) producing a piece of partially-delignified cellulose-based material by subjecting a piece of naturally-occurring cellulose-based material to one or more chemical treatments so as to remove at least some lignin therefrom while preserving a microstructure of the piece of naturally-occurring cellulose-based material, the microstructure comprising cellulose-based longitudinal cells extending along an extension direction that is substantially parallel to a longitudinal growth direction of the naturally-occurring cellulose-based material;

(b) partially drying the piece of partially-delignified cellulose-based material so as to remove some moisture therefrom, the partially-dried piece of partially-delignified cellulose-based material having a moisture content of at least 35%; and

(c) forming the partially-dried piece of partially-delignified cellulose-based material from a substantially flat planar configuration into a non-planar three-dimensional configuration,

wherein lumina of first cellulose-based longitudinal cells in the partially-dried piece of partially-delignified cellulose-based material that have a cross-sectional size less than a first size are substantially collapsed and lumina of second cellulose-based longitudinal cells in the partially-dried piece of partially-delignified cellulose-based material that have a cross-sectional size greater than the first size are at least partially open.

Clause 81. The method of any clause or example herein, in particular any one of Clauses 78-80, further comprising, after the forming into the non-planar three-dimensional configuration:

(e) drying the piece to remove moisture therefrom so as to set a shape of the piece and form a rigid monolithic piece of partially-delignified cellulose-based material in the non-planar three-dimensional configuration, wherein the rigid monolithic piece has a moisture content less than or equal to 15 wt %.

Clause 82. The method of any clause or example herein, in particular any one of Clauses 78-81, wherein the naturally-occurring cellulose-based material is a fibrous plant.
Clause 83. The method of any clause or example herein, in particular Clause 82, wherein the fibrous plant is a hardwood, softwood, bamboo, grass, or reed.
Clause 84. The method of any clause or example herein, in particular any one of Clauses 78-83, wherein:

the subjecting to one or more chemical treatments of (a) is such that a lignin content in the naturally-occurring cellulose-based material is reduced by between 0.1% and 99%, inclusive, to produce the piece of partially-delignified cellulose-based material;

the subjecting to one or more chemical treatments of (a) is such that a hemicellulose content in the naturally-occurring cellulose-based material is reduced by between 0.1% and 99%, inclusive, to produce the piece of partially-delignified cellulose-based material; or

any combination of the above.

Clause 85. The method of any clause or example herein, in particular any one of Clauses 78-84, wherein:

the subjecting to one or more chemical treatments of (a) is such that the lignin content in the naturally-occurring cellulose-based material is reduced by 50% or less to produce the piece of partially-delignified cellulose-based material;

the subjecting to one or more chemical treatments of (a) is such that the hemicellulose content in the naturally-occurring cellulose-based material is reduced by 50% or less to produce the piece of partially-delignified cellulose-based material; or

any combination of the above.

Clause 86. The method of any clause or example herein, in particular any one of Clauses 78-85, wherein:

the subjecting to one or more chemical treatments of (a) is such that a lignin content in the naturally-occurring cellulose-based material is reduced by no more than 10% to produce the piece of partially-delignified cellulose-based material;

the subjecting to one or more chemical treatments of (a) is such that a hemicellulose content in the naturally-occurring cellulose-based material is reduced by no more than 10% to produce the piece of partially-delignified cellulose-based material; or

any combination of the above.

Clause 87. The method of any clause or example herein, in particular any one of Clauses 78-86, wherein:

the naturally-occurring cellulose-based material is a hardwood, and an amount of lignin in the piece of partially-delignified wood after (a) is at least 10 wt %;

the naturally-occurring cellulose-based material is a softwood, and an amount of lignin in the piece of partially-delignified wood after (a) is at least 12.5 wt %; or

the naturally-occurring cellulose-based material is a bamboo, and an amount of lignin in the piece of partially-delignified bamboo after (a) is at least 13 wt %.

Clause 88. A moldable structure formed by the method of any clause or example herein, in particular any one of Clauses 78-87.
Clause 89. A rigid molded structure formed by the method of any clause or example herein, in particular any one of Clauses 78-87.
Clause 90. A structural material comprising:

at least two dried monolithic pieces of partially-delignified cellulose-based material, each dried monolithic piece being formed to have repeating, undulating configuration formed by multiple folds or bends therein, the undulating configuration having a repeating pattern with at least one peak and at least one trough, each dried monolithic piece having a moisture content less than or equal to 15 wt %; and

first and second support plates coupled to the at least two dried monolithic pieces.

Clause 91. The structural material of any clause or example herein, in particular Clause 90, wherein the folds or bends in the undulating configuration are about respective axes parallel to a first direction, and the support plates are disposed on opposite sides of the dried monolithic pieces with respect to the first direction so as to sandwich the monolithic pieces therebetween, and the structural material has a honeycomb configuration.
Clause 92. A moldable structure comprising:

a monolithic piece of partially-delignified, naturally-occurring cellulose-based material having a moisture content of at least 35 wt %,

wherein the monolithic piece has a microstructure where lumina of first cellulose-based longitudinal cells of the naturally-occurring cellulose-based material, which have a cross-sectional size less than a first size, are substantially collapsed and lumina of second cellulose-based longitudinal cells of the naturally-occurring cellulose-based material, which have a cross-sectional size greater than the first size, are at least partially open, and

the cellulose-based longitudinal cells extend along an extension direction that is substantially parallel to a longitudinal growth direction of the naturally-occurring cellulose-based material.

Clause 93. The structure of any clause or example herein, in particular Clause 92, wherein the moisture content is at least 50 wt %.
Clause 94. A molded structure comprising:

the moldable structure of any clause or example herein, in particular any one of Clauses 92-93, formed into a non-planar three-dimensional configuration and subsequently dried to remove moisture therefrom, so as to have a moisture content less than or equal to 15 wt %.

Clause 95. A molded structure comprising:

a dried monolithic piece of partially-delignified, naturally-occurring cellulose-based material formed into a non-planar three-dimensional configuration, the dried monolithic piece having a moisture content less than or equal to 15 wt %,

wherein a microstructure of the dried monolithic piece has lumina of cellulose-based longitudinal cells of the cellulose-based material that are substantially collapsed, each longitudinal cell extending along an extension direction that is substantially parallel to a longitudinal growth direction of the naturally-occurring cellulose-based material.

Clause 96. The structure of any clause or example herein, in particular any one of Clauses 90-95, wherein the naturally-occurring cellulose-based material is a fibrous plant.
Clause 97. The structure of any clause or example herein, in particular Clause 96, wherein the fibrous plant is a hardwood, softwood, bamboo, grass, or reed.

### CONCLUSION

Any of the features illustrated or described with respect to FIGS. 1-15B and Clauses 1-97 can be combined with any other features illustrated or described with respect to FIGS. 1-15B and Clauses 1-97 to provide materials, structures, methods, devices, and embodiments not otherwise illustrated or specifically described herein. For example, the features regarding wet hole formation as described with respect to FIG. 15B can be applied to any other materials described herein, for example, the structures and methodology described with respect to FIGS. 4A-12D. Other combinations and variations are also possible according to one or more contemplated embodiments. All features described herein are independent of one another and, except where structurally impossible, can be used in combination with any other feature described herein.

In view of the many possible embodiments to which the principles of the disclosed technology may be applied, it should be recognized that the illustrated embodiments are only preferred examples and should not be taken as limiting the scope of the disclosed technology. Rather, the scope is defined by the following claims. We therefore claim all that comes within the scope and spirit of these claims.

1. A method comprising:
(a) producing a piece of partially-delignified wood by subjecting a piece of natural wood to one or more chemical treatments so as to remove at least some lignin therefrom while preserving a microstructure of the piece of natural wood, the microstructure comprising cellulose-based longitudinal cells extending along an extension direction that is substantially parallel to a longitudinal growth direction of the natural wood;
(b) drying the piece of partially-delignified wood so as to remove moisture therefrom, such that lumina of at least some of the cellulose-based longitudinal cells collapse and such that the dried piece has a moisture content less than or equal to 15 wt %;
(c) performing a fluid-shock treatment to the dried piece of partially-delignified wood to yield a rehydrated piece of partially-delignified wood, the fluid-shock treatment comprising exposing the dried piece to moisture, the rehydrated piece having a moisture content of at least 35 wt %; and
(d) forming the rehydrated piece of partially-delignified wood from a substantially flat planar configuration into a non-planar three-dimensional configuration,
wherein the lumina of first cellulose-based longitudinal cells in the rehydrated piece of partially-delignified wood that have a cross-sectional size less than a first size are substantially collapsed and lumina of second cellulose-based longitudinal cells in the rehydrated piece of partially-delignified wood that have a cross-sectional size greater than the first size are at least partially open.

2. (canceled)

3. The method of claim 1, wherein the moisture content of the rehydrated piece during (d) is at least 50 wt %.

4. A method comprising:
(a) producing a piece of partially-delignified wood by subjecting a piece of natural wood to one or more chemical treatments so as to remove at least some lignin therefrom while preserving a microstructure of the piece of natural wood, the microstructure comprising cellulose-based longitudinal cells extending along an extension direction that is substantially parallel to a longitudinal growth direction of the natural wood;
(b) partially drying the piece of partially-delignified wood so as to remove some moisture therefrom, the partially-dried piece of partially-delignified wood having a moisture content of at least 35%; and
(c) forming the partially-dried piece of partially-delignified wood from a substantially flat planar configuration into a non-planar three-dimensional configuration,
wherein lumina of first cellulose-based longitudinal cells in the partially-dried piece of partially-delignified wood that have a cross-sectional size less than a first size are substantially collapsed and lumina of second cellulose-based longitudinal cells in the partially-dried piece of partially-delignified wood that have a cross-sectional size greater than the first size are at least partially open.

5-6. (canceled)

7. The method of claim 4, further comprising, after the forming into the non-planar three-dimensional configuration:
(e) drying the piece to remove moisture therefrom so as to set a shape of the piece and form a rigid monolithic piece of partially-delignified wood in the non-planar three-dimensional configuration,
wherein the rigid monolithic piece has a moisture content less than or equal to 15 wt %.

8-11. (canceled)

12. The method of claim 7, further comprising:
forming a protective layer or coating over the rigid monolithic piece, the protective layer or coating being constructed to prevent rehydration of the rigid monolithic piece.

13. (canceled)

14. The method of claim 1, wherein the exposing to moisture of (c) comprises immersing partially or fully within a fluid, exposing to fluid vapor in a humidified environment, or any combination thereof.

15. The method of claim 4, wherein the moisture content of the partially-dried piece during (c) is at least 50 wt %.

16-17. (canceled)

18. The method of claim 4, wherein for each lumen of the second cellulose-based longitudinal cells, a cross-sectional size thereof after the drying of (b) is less than a cross-sectional size thereof in the natural wood prior to (a).

19-20. (canceled)

21. The method of claim 4, wherein:
the subjecting to one or more chemical treatments of (a) is such that a lignin content in the natural wood is reduced by no more than 10% to produce the piece of partially-delignified wood;
the subjecting to one or more chemical treatments of (a) is such that hemicellulose content in the natural wood is reduced by no more than 10% to produce the piece of partially-delignified wood; or
any combination of the above.

22-24. (canceled)

25. The method of claim 4, wherein:
at least one of the one or more chemical treatments comprises partial or full immersion in one or more chemical solutions; and
the one or more chemical solutions comprise sodium hydroxide (NaOH), lithium hydroxide (LiOH), potassium hydroxide (KOH), sodium sulfite (Na₂SO₃), sodium sulfate (Na₂SO₄), sodium sulfide (Na₂S), NaₙS wherein n is an integer, urea (CH₄N₂O), sodium bisulfite (NaHSO₃), sulfur dioxide (SO₂), anthraquinone (C₁₄H₈O₂), methanol (CH₃OH), ethanol (C₂H₅OH), butanol (C₄H₉OH), formic acid (CH₂O₂), hydrogen peroxide (H₂O₂), acetic acid (CH₃COOH), butyric acid (C₄H₈O₂), peroxyformic acid (CH₂O₃), peroxyacetic acid (C₂H₄O₃), ammonia (NH₃), tosylic acid (p-TsOH), sodium hypochlorite (NaClO), sodium chlorite (NaClO₂), chlorine dioxide (ClO₂), chorine (Cl₂), or any combination of the above.

26-50. (canceled)

51. A moldable wood structure comprising:
a monolithic piece of partially-delignified natural wood having a moisture content of at least 35 wt %,
wherein the monolithic piece has a microstructure where lumina of first cellulose-based longitudinal cells of the natural wood, which have a cross-sectional size less than a first size, are substantially collapsed and lumina of second cellulose-based longitudinal cells of the natural wood, which have a cross-sectional size greater than the first size, are at least partially open, and
the cellulose-based longitudinal cells extend along an extension direction that is substantially parallel to a longitudinal growth direction of the natural wood.

52. The wood structure of claim 51, wherein the moisture content is at least 50 wt %.

53. The wood structure of claim 51, wherein for each lumen of the second cellulose-based longitudinal cells, a cross-sectional size thereof in the monolithic piece is less than a cross-sectional size thereof in the natural wood prior to the partial delignification.

54-71. (canceled)

72. The wood structure of claim 51, wherein:
the monolithic piece is produced by reducing a lignin content in the natural wood by no more than 10%;
the monolithic piece is produced by reducing a lignin content in the natural wood by no more than 10%; or
any combination of the above.

73. The wood structure of claim 51, wherein an amount of lignin in the monolithic piece is at least 10 wt %.

74-97. (canceled)

98. The method of claim 1, further comprising, after the forming into the non-planar three-dimensional configuration:
(e) drying the piece to remove moisture therefrom so as to set a shape of the piece and form a rigid monolithic piece of partially-delignified wood in the non-planar three-dimensional configuration,
wherein the rigid monolithic piece has a moisture content less than or equal to 15 wt %.

99. The method of claim 98, further comprising:
forming a protective layer or coating over the rigid monolithic piece, the protective layer or coating being constructed to prevent rehydration of the rigid monolithic piece.

100. The method of claim 1, wherein for each lumen of the second cellulose-based longitudinal cells, a cross-sectional size thereof after the drying of (b) is less than a cross-sectional size thereof in the natural wood prior to (a).

101. The method of claim 1, wherein:
the subjecting to one or more chemical treatments of (a) is such that a lignin content in the natural wood is reduced by no more than 10% to produce the piece of partially-delignified wood;
the subjecting to one or more chemical treatments of (a) is such that hemicellulose content in the natural wood is reduced by no more than 10% to produce the piece of partially-delignified wood; or
any combination of the above.

102. The method of claim 1, wherein:
at least one of the one or more chemical treatments comprises partial or full immersion in one or more chemical solutions; and
the one or more chemical solutions comprise sodium hydroxide (NaOH), lithium hydroxide (LiOH), potassium hydroxide (KOH), sodium sulfite (Na₂SO₃), sodium sulfate (Na₂SO₄), sodium sulfide (Na₂S), NaₙS wherein n is an integer, urea (CH₄N₂O), sodium bisulfite (NaHSO₃), sulfur dioxide (SO₂), anthraquinone (C₁₄H₈O₂), methanol (CH₃OH), ethanol (C₂H₅OH), butanol (C₄H₉OH), formic acid (CH₂O₂), hydrogen peroxide (H₂O₂), acetic acid (CH₃COOH), butyric acid (C₄H₈O₂), peroxyformic acid (CH₂O₃), peroxyacetic acid (C₂H₄O₃), ammonia (NH₃), tosylic acid (p-TsOH), sodium hypochlorite (NaClO), sodium chlorite (NaClO₂), chlorine dioxide (ClO₂), chorine (Cl₂), or any combination of the above.
